(19) United States
(12) Patent Application Publication
(10) Pub. No.: US 2020/0396767 A1
(43) Pub. Date: Dec. 17, 2020

(54) FRAME-BASED EQUIPMENT FRAMEWORK FOR NEW RADIO SYSTEMS OPERATING ON UNLICENSED BANDS

(71) Applicant: Intel Corporation, Santa Clara, CA (US)

(72) Inventors: Salvatore Talarico, Los Gatos, CA (US); Yongjun Kwak, Portland, OR (US); Yingyang Li, Beijing (CN); Carlos H. Aldana, Mountain View, CA (US)

(73) Assignee: Intel Corporation, Santa Clara, CA (US)

(21) Appl. No.: 17/003,858

(22) Filed: Aug. 26, 2020

Related U.S. Application Data
(60) Provisional application No. 62/932,093, filed on Nov. 7, 2019.
(60) Provisional application No. 62/909,990, filed on Oct. 3, 2019.
(60) Provisional application No. 62/892,430, filed on Aug. 27, 2019.

(51) Int. Cl. H04W 74/08; H04W 16/14

(52) U.S. Cl. CPC H04W 74/0808; H04W 16/14

(57) ABSTRACT

An apparatus of a User Equipment (UE), a computer-readable media, and a method. The apparatus includes one or more processors to: determine a time gap between an end of a downlink (DL) transmission burst from a gNB and a beginning of a following uplink (UL) transmission burst from the UE within a channel operating time (COT) of the FFP; in response to a determination that the time gap is less than or equal to 16 μs, perform a CAT-1 listen-before-talk (LBT) operation to gain access to an operating channel; in response to a determination that the time gap is more than 16 μs, perform a CAT-2 LBT operation to gain access to the operating channel; and cause the UE to transmit the UL transmission burst to the gNB on the operating channel and within a fixed frame period after performing the CAT-1 or CAT-2 LBT operation.

### CROSS REFERENCE TO RELATED APPLICATIONS

This application claims the benefit of and priority from U.S. Provisional Patent Application No. 62/892,430 entitled “FBE FRAMEWORK FOR NR SYSTEMS OPERATING ON UNLICENSED SPECTRUM” filed Aug. 27, 2019, U.S. Provisional Patent Application No. 62/909,990 entitled “FBE FRAMEWORK FOR NR SYSTEMS OPERATING ON UNLICENSED SPECTRUM,” filed Oct. 3, 2019, and U.S. Provisional Patent Application No. 62/932,093 entitled “FBE FRAMEWORK FOR NR SYSTEMS OPERATING ON UNLICENSED SPECTRUM,” filed Nov. 7, 2019, the entire disclosures of which are incorporated herein by reference.

### BACKGROUND

Various embodiments generally may relate to the field of wireless communications, for example to communications concerning frame-based equipment (FBE) in the unlicensed spectrum.

### BRIEF DESCRIPTION OF THE DRAWINGS

FIG. 1 illustrates an example architecture of a system of a network, in accordance with various embodiments.

FIG. 2 illustrates an example architecture of a system including a first core network, in accordance with various embodiments.

FIG. 3 illustrates an architecture of a system including a second core network in accordance with various embodiments.

FIG. 4 illustrates an example of a platform or device in accordance with various embodiments.

FIG. 5 illustrates example components of baseband circuitry and radio front end modules (RFEM) in accordance with various embodiments.

FIG. 6 illustrates various protocol functions that may be implemented in a wireless communication device according to various embodiments.

FIG. 7 illustrates a block diagram showing components, according to some example embodiments, able to read instructions from a machine-readable or computer-readable medium (e.g., a non-transitory machine-readable storage medium) and perform any one or more of the methodologies discussed herein.

FIG. 8 illustrates a fixed frame period including a DL burst followed by a UL burst transmitted on an unlicensed band.

FIG. 9 illustrates a graph plotting fixed frame period (FFP) in ms versus the maximum percentage of FFP used as channel occupancy time.

FIG. 10 illustrates an embodiment where the hybrid automatic repeat request (HARQ) acknowledgment (ACK) is transmitted in a specific slot(s) of the FFP or in a specific slot(s) of each UL bursts within a valid FFP.

FIG. 11 illustrates an embodiment where HARQ-ACK feedback for a previous group downlink transmission that belongs to a first FFP may be transmitted in a second FFP after the first FFP.

FIG. 12 illustrates a flow for a first method according to a first embodiment.

FIG. 13 illustrates a flow for a second method according to a second embodiment.

Like reference numbers and designations in the various drawings indicate like elements.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Each year, the number of mobile devices connected to wireless networks significantly increases. In order to keep up with the demand in mobile data traffic, necessary changes have to be made to system requirements to be able to meet these demands. Three critical areas that need to be enhanced in order to deliver this increase in traffic are larger bandwidth, lower latency, and higher data rates.

One of the major limiting factors in wireless innovation is the availability in spectrum. To mitigate the above, the unlicensed spectrum has been an area of interest to expand the availability of Long Term Evolution (LTE). In this context, one of the major enhancement for LTE in the Third Generation Partnership Project (3GPP) Release 13 has been to enable its operation in the unlicensed spectrum via Licensed-Assisted Access (LAA), which expands the system bandwidth by utilizing the flexible carrier aggregation (CA) framework introduced by the LTE-Advanced system.

Given that building blocks for the framework of New Radio (NR or 5G) have been established, a natural enhancement is to allow NR to also operate on the unlicensed spectrum. The work to introduce shared/unlicensed spectrum in 5G NR has already begun, and a new work item (WI) on “NR-Based Access to Unlicensed Spectrum” was approved in TSG RAN Meeting #82. One objective of this new WI concern a determination of the following:
Physical layer aspects including (Radio Access Network) [RAN1]:
   Frame structure including single and multiple downlink (DL) to uplink (UL) and UL to DL switching points within a shared channel occupancy time (COT) with associated identified listen-before-talk (LBT) requirements (3GPP TR 38.889 v16.0.0 (2018 Dec. 19) Section 7.2.1.3.1).
   UL data channel including extension of physical uplink shared channel (PUSCH) to support physical resource block (PRB)-based frequency block-interlaced transmission; support of multiple PUSCH(s) starting positions in one or multiple slot(s) depending on the LBT outcome with the understanding that the ending position is indicated by the UL grant. A design not requiring the user equipment (UE) to change a granted transport block size (TBS) for a PUSCH transmission depending on the LBT outcome.
   The necessary PUSCH enhancements based on cyclic prefix-orthogonal frequency division multiplexing (CP-OFDM). Applicability of sub-PRB frequency block-interlaced transmission for 60 kHz to be decided by RAN1.
Physical layer procedure(s) including [RAN1, RAN2]:
   For load-based equipment (LBE), a channel access mechanism in line with agreements from the NR unlicensed band (NR-U) study item (3GPP TR 38.889, Section 7.2.1.3.1), with specification work to be performed by RAN1.
   HARQ operation: NR HARQ feedback mechanisms are the baseline for NR-U operation with extensions, in line with agreements during the study phase (3GPP TR 38.889, Section 7.2.1.3.3), including immediate transmission of HARQ A/N for the corresponding data in the same shared COT as well as transmission of HARQ A/N in a subsequent COT. Potentially support mechanisms to provide multiple and/or supplemental time and/or frequency domain transmission opportunities. (RAN1).
   Scheduling multiple transmission time intervals (TTIs) for PUSCH in-line with agreements from the study phase (3GPP TR 38.889, Section 7.2.1.3.3). (RAN1).
   Configured Grant operation: NR Type-1 and Type-2 configured grant mechanisms are the baseline for NR-U operation with modifications in line with agreements during the study phase (3GPP TR 38.889, Section 7.2.1.3.4). (RAN1).
   Data multiplexing aspects (for both UL and DL) considering LBT and channel access priorities. (RAN1/RAN2)

While this WI is at its initial stage, it is important to identify aspects of the design that can be enhanced for NR when operating in an unlicensed spectrum. One of the challenges in this regard is that this system must maintain fair coexistence with other incumbent technologies, and in order to do so, depending on the particular band in which it might operate, some restrictions might be taken into account when designing the system. For instance, if operating in the 5 GHz band, a LBT procedure needs to be performed in some parts of the world to acquire the medium before a transmission can occur. For this particular band, the European Telecommunications Standards Institute (ETSI) European Standard, telecommunications series (EN) (ETSI EN) 301 893 provides the regulatory requirements that must be met in order to be able to operate within the European Union (EU), or other countries, that follow the ETSI rules.

According to some embodiments, channel access mechanisms are defined for either load based equipment (LBE), or frame based equipment (FBE). While LAA/enhanced-Licensed Assisted Access (eLAA)/further enhanced-Licensed Assisted Access (feLAA) design has been developed for the channel access procedure that uses load based access, two separate design have been envisioned for NR-U: i) the first design is based on the channel access procedure for load based access; ii) and the second design is instead based on the channel access procedure for frame based access.

While the regulatory requirements related to FBE are quite simple, and allow in principle to operate Release 15 NR (Rel. 15 NR) on the unlicensed spectrum, some of the limitations of FBE may benefit from some changes. This disclosure provides details on the frame structure design for the FBE for NR operating on the unlicensed spectrum.

To enable FBE operation of the Rel.15 NR design within the 5 GHz band, some modifications might be required to comply with all the regulatory requirements mandated by the ETSI Broadband RAN (BRAN). The instant disclosure among other things provides some details regarding embodiments for such modifications.

Background on 5 GHz Band ETSI Regulation:

ETSI EN 301 893 V2.1.3 defines the latest 5 GHz unlicensed band regulatory requirements for the EU. In this document, channel access mechanisms are defined for either load based equipment (LBE), or frame based equipment (FBE). While LAA/eLAA/feLAA design has been developed for the channel access procedure that uses load based access, two separate design have been envisioned for NR-U: i) the first design is based on the channel access procedure for load based access; ii) and the second design is instead based on the channel access procedure for frame based access.

For the latter design, the following are the most relevant pieces of regulations in ETSI EN 301 893 V2.1.3:
“Frame Based Equipment shall implement a Listen Before Talk (LBT) based Channel Access Mechanism to detect the presence of other [radio local area network] (RLAN) transmissions on an Operating Channel. Frame Based Equipment is equipment where the transmit/receive structure has a periodic timing with a periodicity equal to the Fixed Frame Period. A single Observation Slot as defined in clause 3.1 and as referenced by the procedure in clause 4.2.7.3.1.4 shall have a duration of not less than 9 μs.”
“The Fixed Frame Periods supported by the equipment shall be declared by the manufacturer. See clause 5.4.1, item q). This shall be within the range of 1 ms to 10 ms. Transmissions can start only at the beginning of a Fixed Frame Period. . . . An equipment may change its Fixed Frame Period but it shall not do more than once every 200 ms.”

The first bullet above indicates that for FBE channel access, the transmit/receive structure is periodic, and each frame is at most 10 ms long. The second bullet highlights that the frame period is generally fixed and can be modified no more than once every 200 ms.

When a system operates in FBE mode, a device can be defined as: i) an “initiating device”, which is the device that initiates a sequence of one or more transmissions; ii) a “responding device”; (iii) or both.

Up to Release 16 of NR, only gNB can operate as an initiating device. Since the gNB is the only initiating device, a framework has been created to accommodate the same regarding a gNB's listen before talk (LBT) performance for each fixed frame period (FFP). When a gNB is able to succeed in the LBT, then, the FFP is considered valid. Thus, a valid FFP is a FFP that a gNB has been able to successfully acquire, and able to share with the UEs, so that the gNB and the UEs associated with that gNB can transmit within the FFP. Otherwise, if the LBT fails, the FFP is considered invalid.

Some regulation regarding FFP mandate that when an initiating device, the gNB, acquires a FFP, it should leave an idle period at the end of the FFP where there are no transmissions.

In the idle period or gap, transmission are muted. The idle period corresponds to an interval between one sets of transmissions to allow other devices to perform LBT, and this it to ensure that use of unlicensed bands in cellular networks can coexist with other incumbent systems.

Some embodiments concern the positioning of the idle period within a FFP, and its duration. Some embodiments provide that the idle period correspond to about 5% of the COT or 100 microseconds.

For an initiating device, its channel access mechanism must comply with the requirements provided in ETSI EN 301 893 V2.1.3, Section 4.2.7.3.1.4, while for a responding device its set of requirements for the channel access are provided in ETSI EN 301 893 V2.1.3, Section 4.2.7.3.1.5, as provided below.

For an initiating device:
a. Immediately starting transmission within a fixed frame period, it shall perform CCA. If the channel is clear, the initiating device may transmit immediately;
b. It is allowed to perform short control signaling transmissions without sensing the channel for the presence of other signals, if
   within an observation period of SO ms, the number of Short Control Signaling Transmissions by the equipment shall be equal to or less than SO; and
   the total duration of the equipment's Short Control Signaling Transmissions shall be less than 2 500 μs within said observation period.
c. Multiple transmissions are permitted within a COT if the gap between transmissions does not exceed 16 μs. Otherwise an initiating device may perform CCA before transmission.
d. It is allowed to grant authorization to one or more associated responding devices.
e. The COT shall not be greater than 95% of the fixed frame period.
f. Upon correct reception of a packet which was intended for this equipment, it can skip CCA and immediately proceed with the transmission of management and control frames (e.g. ACK and Block ACK frames). A consecutive sequence of such transmissions by the equipment, without it performing a new CCA, shall not exceed the Maximum Channel Occupancy Time.

For a responding device, that received a transmission grant from an associated initiating device, it may proceed with transmissions on the current operating channel:
The responding device may proceed with such transmissions without performing a CC if these transmissions are initiated at most 16 μs after the last transmission by the initiating device that issued the grant.
The responding device that does not proceed with such transmissions within 16 μs after the last transmission from the Initiating Device that issued the grant, shall perform a CCA on the Operating Channel during a single observation slot within a 25 μs period ending immediately before the granted transmission time. If CCA fails, the responding device withdrawn the transmission grant, otherwise it may perform transmissions on the current operating channel for the remaining channel occupancy time of the current fixed frame period. In this case, the responding device may have multiple transmissions on this operating channel provided that the gap in between such transmissions does not exceed 16 μs. When the transmissions by the responding device are completed the responding device shall withdraw the transmission grant provided by the initiating device.

Similarly, as for the LBE, FBE must comply with the regulatory requirements set regarding the occupied bandwidth, which are summarized herein
“The Occupied Channel Bandwidth shall be between 80% and 100% of the Nominal Channel Bandwidth. In case of smart antenna systems (devices with multiple transmit chains) each of the transmit chains shall meet this requirement. The Occupied Channel Bandwidth might change with time/payload.
During a Channel Occupancy Time (COT), equipment may operate temporarily with an Occupied Channel Bandwidth of less than 80% of its Nominal Channel Bandwidth with a minimum of 2 MHz.”

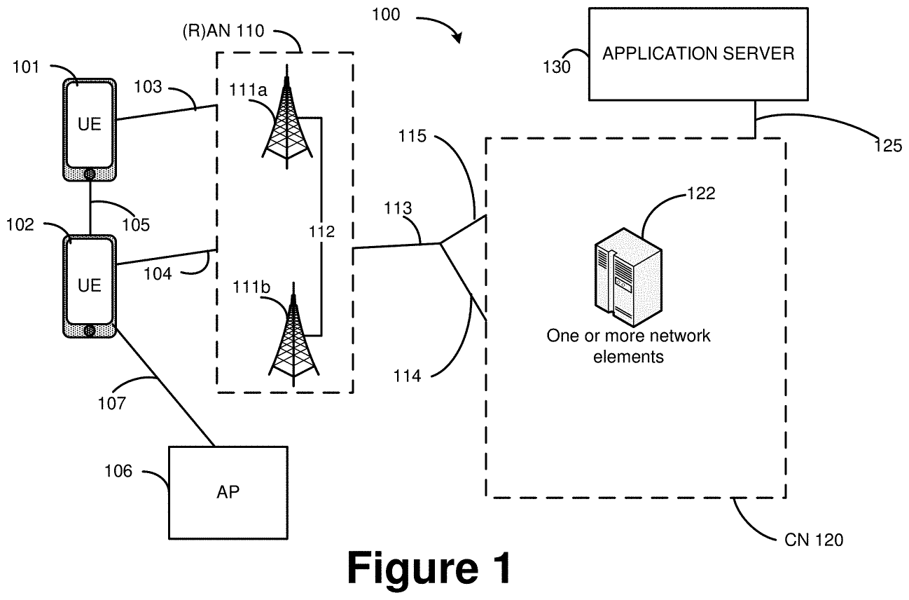

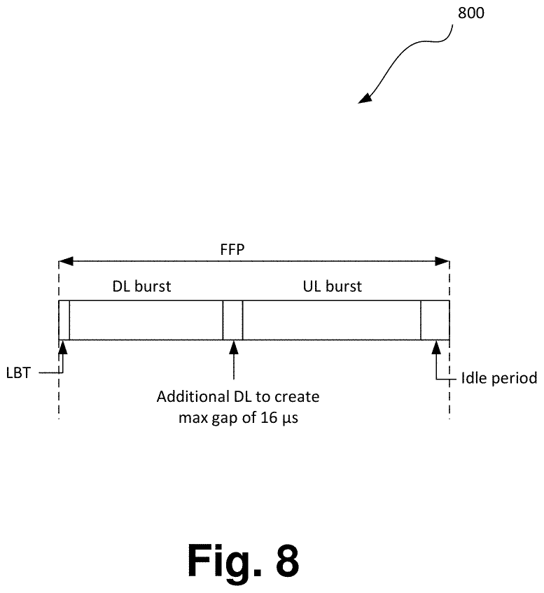

FIGS. 1-7 below illustrate implementation networks, architectures and/or systems that may be used to perform one or more operations, techniques, processes, and/or methods as described in the present disclosure, such as with respect to the exemplary embodiments of FIGS. 8-13 to be addressed further below.

### Some Embodiments for Systems and Implementations

FIG. 1 illustrates an example architecture of a system 100 of a network, in accordance with various embodiments. The following description is provided for an example system 100 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 1, the system 100 includes UE 101a and UE 101b (collectively referred to as “UEs 101” or “UE 101”). In this example, UEs 101 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 101 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 101 may be configured to connect, for example, communicatively couple, with an or RAN 110. In embodiments, the RAN 110 may be an NG RAN or a SG RAN, an E-UTRAN, or a legacy RAN, such as a UTRAN or GERAN. As used herein, the term “NG RAN” or the like may refer to a RAN 110 that operates in an NR or SG system 100, and the term “E-UTRAN” or the like may refer to a RAN 110 that operates in an LTE or 4G system 100. The UEs 101 utilize connections (or channels) 103 and 104, respectively, each of which comprises a physical communications interface or layer (discussed in further detail below).

In this example, the connections 103 and 104 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a SG protocol, a NR protocol, and/or any of the other communications protocols discussed herein. In embodiments, the UEs 101 may directly exchange communication data via a ProSe interface 10S. The ProSe interface 10S may alternatively be referred to as a SL interface 10S and may comprise one or more logical channels, including but not limited to a PSCCH, a PSSCH, a PSDCH, and a PSBCH.

The UE 101b is shown to be configured to access an AP 106 (also referred to as “WLAN node 106,” “WLAN 106,” “WLAN Termination 106,” “WT 106” or the like) via connection 107. The connection 107 can comprise a local wireless connection, such as a connection consistent with any IEEE 802.11 protocol, wherein the AP 106 would comprise a wireless fidelity (Wi-Fi®) router. In this example, the AP 106 is shown to be connected to the Internet without connecting to the core network of the wireless system (described in further detail below). In various embodiments, the UE 101b, RAN 110, and AP 106 may be configured to utilize LWA operation and/or LWIP operation. The LWA operation may involve the UE 101b in RRC_CONNECTED being configured by a RAN node 111a-b to utilize radio resources of LTE and WLAN. LWIP operation may involve the UE 101b using WLAN radio resources (e.g., connection 107) via IPsec protocol tunneling to authenticate and encrypt packets (e.g., IP packets) sent over the connection 107. IPsec tunneling may include encapsulating the entirety of original IP packets and adding a new packet header, thereby protecting the original header of the IP packets.

The RAN 110 can include one or more AN nodes or RAN nodes 111a and 111b (collectively referred to as “RAN nodes111” or “RAN node 111”) that enable the connections 103 and 104. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 111 that operates in an NR or SG system 100 (for example, a gNB), and the term “E-UTRAN node” or the like may refer to a RAN node 111 that operates in an LTE or 4G system 100 (e.g., an eNB). According to various embodiments, the RAN nodes 111 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

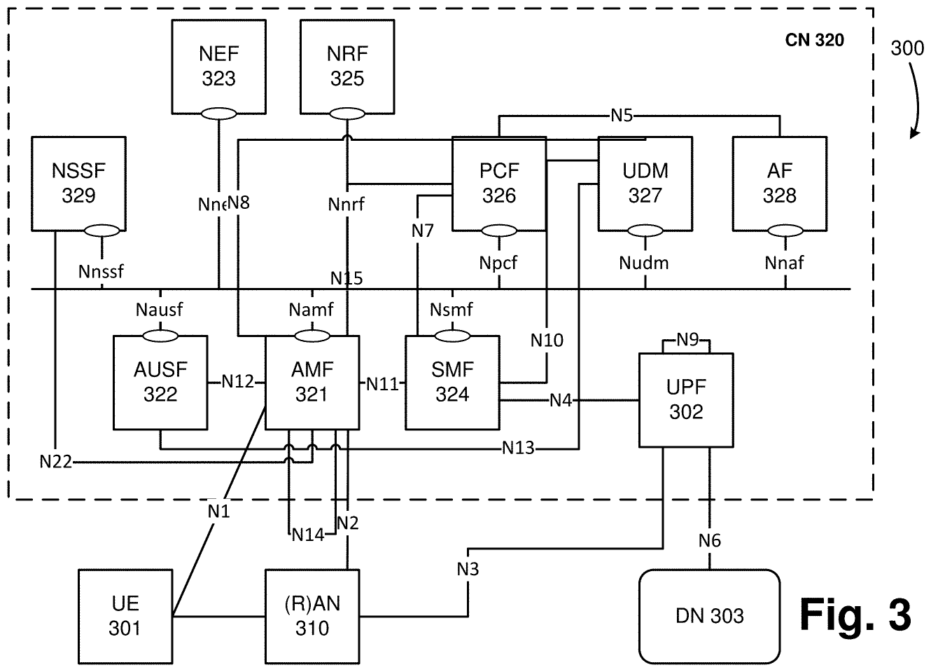

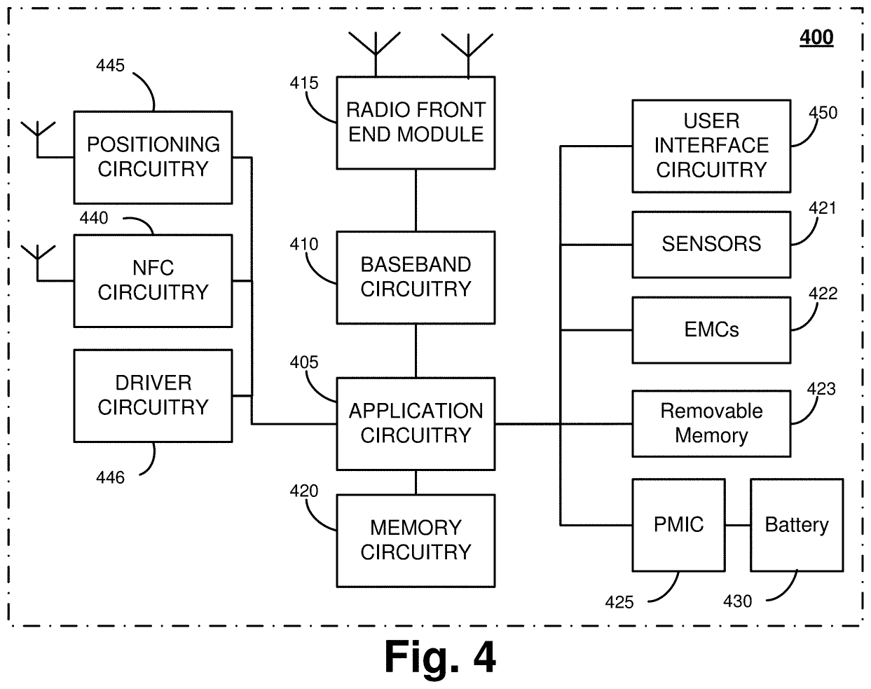

In some embodiments, all or parts of the RAN nodes 111 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 111; a MAC/PHY split wherein RRC, PDCP, RLC, and MAC layers are operated by the CRAN/vBBUP and the PHY layer is operated by individual RAN nodes 111; or a “lower PHY” split wherein RRC, PDCP, RLC, MAC layers and upper portions of the PHY layer are operated by the CRAN/vBBUP and lower portions of the PHY layer are operated by individual RAN nodes 111. This virtualized framework allows the freed-up processor cores of the RAN nodes 111 to perform other virtualized applications. In some implementations, an individual RAN node 111 may represent individual gNB-DUs that are connected to a gNB-CU via individual Fl interfaces (not shown by FIG. 1). In these implementations, the gNB-DUs may include one or more remote radio heads or RFEMs (see, e.g., FIG. 4), and the gNB-CU may be operated by a server that is located in the RAN 110 (not shown) or by a server pool in a similar manner as the CRAN/vBBUP. Additionally or alternatively, one or more of the RAN nodes 111 may be next generation eNBs (ng-eNBs), which are RAN nodes that provide E-UTRA user plane and control plane protocol terminations toward the UEs 101, and are connected to a SGC (e.g., CN 320 of FIG. 3) via an NG interface (discussed infra). In V2X scenarios one or more of the RAN nodes 111 may be or act as RSUs. The term “Road

Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 101 (vUEs 101). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 111 can terminate the air interface protocol and can be the first point of contact for the UEs 101. In some embodiments, any of the RAN nodes 111 can fulfill various logical functions for the RAN 110 including, but not limited to, radio network controller (RNC) functions such as radio bearer management, uplink and downlink dynamic radio resource management and data packet scheduling, and mobility management.

In embodiments, the UEs 101 can be configured to communicate using OFDM communication signals with each other or with any of the RAN nodes 111 over a multicarrier communication channel in accordance with various communication techniques, such as, but not limited to, an OFDMA communication technique (e.g., for downlink communications) or a SC-FD MA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 111 to the UEs 101, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 101 and the RAN nodes 111 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 101 and the RAN nodes 111 may operate using LAA, eLAA, and/or feLAA mechanisms. In these implementations, the UEs 101 and the RAN nodes 111 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 101 RAN nodes 111, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA Here, when a WLAN node (e.g., a mobile station (MS) such as UE 101, AP 106, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 101 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 101. The PDCCH carries information about the transport format and resource allocations related to the PDSCH channel, among other things. It may also inform the UEs 101 about the transport format, resource allocation, and HARQ information related to the uplink shared channel. Typically, downlink scheduling (assigning control and shared channel resource blocks to the UE 101b within a cell) may be performed at any of the RAN nodes 111 based on channel quality information fed back from any of the UEs 101. The downlink resource assignment information may be sent on the PDCCH used for (e.g., assigned to) each of the UEs 101.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an ERE Gs. An ECCE may have other numbers of ERE Gs in some situations.

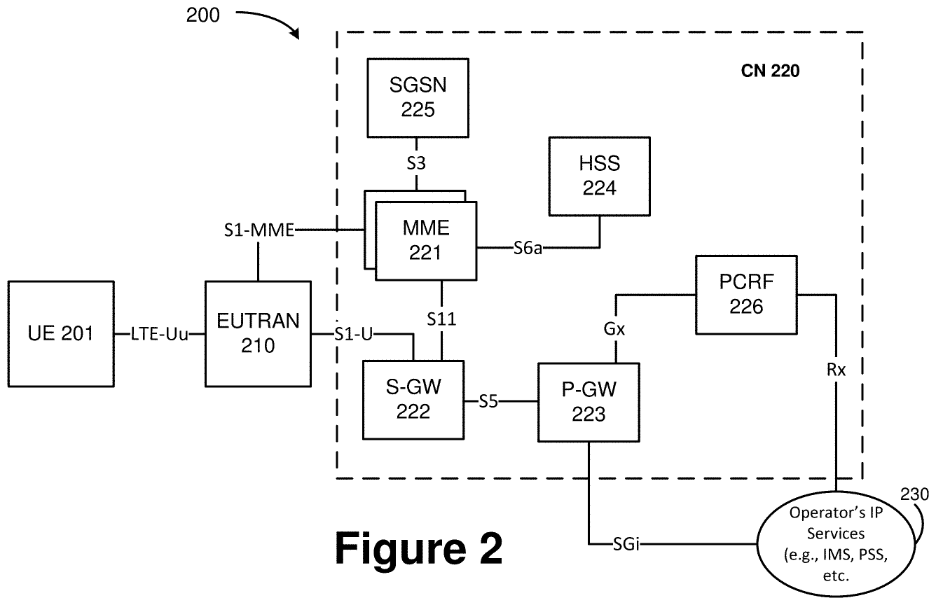

The RAN nodes 111 may be configured to communicate with one another via interface 112. In embodiments where the system 100 is an LTE system (e.g., when CN 120 is an EPC 220 as in FIG. 2), the interface 112 may be an X2 interface 112. The X2 interface may be defined between two or more RAN nodes 111 (e.g., two or more eNBs and the like) that connect to EPC 120, and/or between two eNBs connecting to EPC 120. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 101 from an SeNB for user data; information of PDCP PDUs that were not delivered to a UE 101; information about a current minimum desired buffer size at the Se NB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 100 is a SG or NR system (e.g., when CN 120 is an SGC 320 as in FIG. 3), the interface 112 may be an Xn interface 112. The Xn interface is defined between two or more RAN nodes 111 (e.g., two or more gNBs and the like) that connect to SGC 120, between a RAN node 111 (e.g., a gNB) connecting to SGC 120 and an eNB, and/or between two eNBs connecting to 5GC 120. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 101 in a connected mode (e.g., CM-CONNECTED) including functionality to manage the UE mobility for connected mode between one or more RAN nodes 111. The mobility support may include context transfer from an old (source) serving RAN node 111 to new (target) serving RAN node 111; and control of user plane tunnels between old (source) serving RAN node 111 to new (target) serving RAN node 111. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 110 is shown to be communicatively coupled to a core network-in this embodiment, core network (CN) 120. The CN 120 may comprise a plurality of network elements 122, which are configured to offer various data and telecommunications services to customers/subscribers (e.g., users of UEs 101) who are connected to the CN 120 via the RAN 110. The components of the CN 120 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 130 may be an element offering applications that use IP bearer resources with the core network (e.g., UMTS PS domain, LTE PS data services, etc.). The application server 130 can also be configured to support one or more communication services (e.g., VoIP sessions, PTT sessions, group communication sessions, social networking services, etc.) for the UEs 101 via the EPC 120.

In embodiments, the CN 120 may be a SGC (referred to as “SGC 120” or the like), and the RAN 110 may be connected with the CN 120 via an NG interface 113. In embodiments, the NG interface 113 may be split into two parts, an NG user plane (NG-U) interface 114, which carries traffic data between the RAN nodes 111 and a UPF, and the Sl control plane (NG-C) interface 115, which is a signaling interface between the RAN nodes 111 and AMFs. Embodiments where the CN 120 is a SGC 120 are discussed in more detail with regard to FIG. 3.

In embodiments, the CN 120 may be a SG CN (referred to as “SGC 120” or the like), while in other embodiments, the CN 120 may be an EPC). Where CN 120 is an EPC (referred to as “EPC 120” or the like), the RAN 110 may be connected with the CN 120 via an S1 interface 113. In embodiments, the S1 interface 113 may be split into two parts, an S1 user plane (S1-U) interface 114, which carries traffic data between the RAN nodes 111 and the S-GW, and the S1-MME interface 115, which is a signaling interface between the RAN nodes 111 and MMEs.

FIG. 2 illustrates an example architecture of a system 200 including a first CN 220, in accordance with various embodiments. In this example, system 200 may implement the LTE standard wherein the CN 220 is an EPC 220 that corresponds with CN 120 of FIG. 1. Additionally, the UE 201 may be the same or similar as the UEs 101 of FIG. 1, and the E-UTRAN 210 may be a RAN that is the same or similar to the RAN 110 of FIG. 1, and which may include RAN nodes 111 discussed previously. The CN 220 may comprise MMEs 221, an S-GW 222, a P-GW 223, a HSS 224, and a SGSN 225.

The MMEs 221 may be similar in function to the control plane of legacy SGSN, and may implement MM functions to keep track of the current location of a UE 201. The MMEs 221 may perform various MM procedures to manage mobility aspects in access such as gateway selection and tracking area list management MM (also referred to as “EPS MM” or “EMM” in E-UTRAN systems) may refer to all applicable procedures, methods, data storage, etc. that are used to maintain knowledge about a present location of the UE 201, provide user identity confidentiality, and/or perform other like services to users/subscribers. Each UE 201 and the MME 221 may include an MM or EMM sublayer, and an MM context maybe established in the UE 201 and the MME 221 when an attach procedure is successfully completed. The MM context may be a data structure or database object that stores MM-related information of the UE 201. The MMEs 221 may be coupled with the HSS 224 via an S6a reference point, coupled with the SGSN 225 via an S3 reference point, and coupled with the S-GW 222 via an S11 reference point.

The SGSN 225 may be a node that serves the UE 201 by tracking the location of an individual UE 201 and performing security functions. In addition, the SGSN 225 may perform Inter-EPC node signaling for mobility between 2G/3G and E-UTRAN 3GPP access networks; PDN and S-GW selection as specified by the MMEs 221; handling of UE 201 time zone functions as specified by the MMEs 221; and MME selection for handovers to E-UTRAN 3GPP access network. The S3 reference point between the MMEs 221 and the SGSN 225 may enable user and bearer information exchange for inter-3GPP access network mobility in idle and/or active states.

The HSS 224 may comprise a database for network users, including subscription-related information to support the network entities' handling of communication sessions. The EPC 220 may comprise one or several HSSs 224, depending on the number of mobile subscribers, on the capacity of the equipment, on the organization of the network, etc. For example, the HSS 224 can provide support for routing/roaming, authentication, authorization, naming/addressing resolution, location dependencies, etc. An S6a reference point between the HSS 224 and the MMEs 221 may enable transfer of subscription and authentication data for authenticating/authorizing user access to the EPC 220 between HSS 224 and the MMEs 221.

The S-GW 222 may terminate the S1 interface 113 (“S1-U” in FIG. 2) toward the RAN 210, and routes data packets between the RAN 210 and the EPC 220. In addition, the S-GW 222 may be a local mobility anchor point for inter-RAN node handovers and also may provide an anchor for inter-3GPP mobility. Other responsibilities may include lawful intercept, charging, and some policy enforcement. The S11 reference point between the S-GW 222 and the MMEs 221 may provide a control plane between the MMEs 221 and the S-GW 222. The S-GW 222 may be coupled with the P-GW 223 via an SS reference point.

The P-GW 223 may terminate an SGi interface toward a PDN 230. The P-GW 223 may route data packets between the EPC 220 and external networks such as a network including the application server 130 (alternatively referred to as an “AF”) via an IP interface 125 (see e.g., FIG. 1). In embodiments, the P-GW 223 may be communicatively coupled to an application server (application server 130 of FIG. 1 or PDN 230 in FIG. 2) via an IP communications interface 125 (see, e.g., FIG. 1). The SS reference point between the P-GW 223 and the S-GW 222 may provide user plane tunneling and tunnel management between the P-GW 223 and the S-GW 222. The SS reference point may also be used for S-GW 222 relocation due to UE 201 mobility and if the S-GW 222 needs to connect to a non-collocated P-GW 223 for the required PDN connectivity. The P-GW 223 may further include a node for policy enforcement and charging data collection (e.g., PCEF (not shown)). Additionally, the SGi reference point between the P-GW 223 and the packet data network (PDN) 230 may be an operator external public, a private PDN, or an intra operator packet data network, for example, for provision of IMS services. The P-GW 22 3 may be coupled with a PCRF 226 via a Gx reference point

PCRF 226 is the policy and charging control element of the EPC 220. In a non-roaming scenario, there may be a single PCRF 226 in the Home Public Land Mobile Network (HPLMN) associated with a UE 201's Internet Protocol Connectivity Access Network (IP-CAN) session. In a roaming scenario with local breakout of traffic, there may be two PCRFs associated with a UE 201's IP-CAN session, a Home PCRF (H-PCRF) within an HPLMN and a Visited PCRF (V-PCRF) within a Visited Public Land Mobile Network (VPLMN). The PCRF 226 may be communicatively coupled to the application server 230 via the P-GW 223. The application server 230 may signal the PCRF 226 to indicate a new service flow and select the appropriate QoS and charging parameters. The PCRF 226 may provision this rule into a PCEF (not shown) with the appropriate TFT and QCI, which commences the QoS and charging as specified by the application server 230. The Gx reference point between the PCRF 226 and the P-GW 223 may allow for the transfer of QoS policy and charging rules from the PCRF 226 to PCEF in the P-GW 223. An Rx reference point may reside between the PDN 230 (or “AF 230”) and the PCRF 226.

FIG. 3 illustrates an architecture of a system 300 including a second CN 320 in accordance with various embodiments. The system 300 is shown to include a UE 301, which may be the same or similar to the UEs 101 and UE 201 discussed previously; a (R)AN 310, which may be the same or similar to the RAN 110 and RAN 210 discussed previously, and which may include RAN nodes 111 discussed previously; and a DN 303, which may be, for example, operator services, Internet access or 3rd party services; and a SGC 320. The SGC 320 may include an AUSF 322; an AMF 321; a SMF 324; a NEF 323; a PCF 326; a NRF 325; a UDM 327; an AF 328; a UPF 302; and a NSSF 329.

The UPF 302 may act as an anchor point for intra-RAT and inter-RAT mobility, an external PDU session point of interconnect to DN 303, and a branching point to support multi-homed PDU session. The UPF 302 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 302 may include an uplink classifier to support routing traffic flows to a data network. The DN 303 may represent various network operator services, Internet access, or third party services. DN 303 may include, or be similar to, application server 130 discussed previously. The UPF 302 may interact with the SMF 324 via an N4 reference point between the SMF 324 and the UPF 302.

The AUSF 322 may store data for authentication of UE 301 and handle authentication-related functionality. The AUSF 322 may facilitate a common authentication framework for various access types. The AUSF 322 may communicate with the AMF 321 via an N12 reference point between the AMF 321 and the AUSF 322; and may communicate with the UDM 327 via an N13 reference point between the UDM 327 and the AUSF 322. Additionally, the AUSF 322 may exhibit an Nausf service-based interface.

The AMF 321 may be responsible for registration management (e.g., for registering UE 301, etc.), connection management, reachability management, mobility management, and lawful interception of AMF-related events, and access authentication and authorization. The AMF 321 may be a termination point for the N11 reference point between the AMF 321 and the SMF 324. The AMF 321 may provide transport for SM messages between the UE 301 and the SMF 324, and act as a transparent proxy for routing SM messages. AMF 321 may also provide transport for SMS messages between UE 301 and an SMSF (not shown by FIG. 3). AMF 321 may act as SEAF, which may include interaction with the AUSF 322 and the UE 301, receipt of an intermediate key that was established as a result of the UE 301 authentication process. Where USIM based authentication is used, the AMF 321 may retrieve the security material from the AUSF 322. AMF 321 may also include a SCM function, which receives a key from the SEA that it uses to derive access-network specific keys. Furthermore, AMF 321 may be a termination point of a RAN CP interface, which may include or be an N2 reference point between the (R)AN 310 and the AMF 321; and the AMF 321 may be a termination point of NAS (Nl) signaling, and perform NAS ciphering and integrity protection.

AMF 321 may also support NAS signaling with a UE 301 over an N3 IWF interface. The N3IWF may be used to provide access to untrusted entities. N3IWF may be a termination point for the N2 interface between the (R)AN 310 and the AMF 321 for the control plane, and may be a termination point for the N3 reference point between the (R)AN 310 and the UPF 302 for the user plane. As such, the AMF 321 may handle N2 signaling from the SMF 324 and the AMF 321 for PDU sessions and QoS, encapsulate/de-encapsulate packets for IPSec and N3 tunneling, mark N3 user-plane packets in the uplink, and enforce QoS corresponding to N3 packet marking taking into account QoS requirements associated with such marking received over N2. N3IWF may also relay uplink and downlink control-plane NAS signaling between the UE 301 and AMF 321 via an Nl reference point between the UE 301 and the AMF 321, and relay uplink and downlink user-plane packets between the UE 301 and UPF 302. The N3IWF also provides mechanisms for IPsec tunnel establishment with the UE 301. The AMF 321 may exhibit an Namf service-based interface, and may be a termination point for an Nl 4 reference point between two AMFs 3 21 and an Nl 7 reference point between the AMF 321 and a SG-EIR (not shown by FIG. 3).

The UE 301 may need to register with the AMF 321 in order to receive network services. RM is used to register or deregister the UE 301 with the network (e.g., AMF 321), and establish a UE context in the network (e.g., AMF 321). The UE 301 may operate in an RM-REGISTERED state or an RM-DEREGISTERED state. In the RM-DEREGISTERED state, the UE 301 is not registered with the network, and the UE context in AMF 321 holds no valid location or routing information for the UE 301 so the UE 301 is not reachable by the AMF 321. In the RM-REGISTERED state, the UE 301 is registered with the network, and the UE context in AMF 321 may hold a valid location or routing information for the UE 301 so the UE 301 is reachable by the AMF 321. In the RM-REGISTERED state, the UE 301 may perform mobility Registration Update procedures, perform periodic Registration Update procedures triggered by expiration of the periodic update timer (e.g., to notify the network that the UE 301 is still active), and perform a Registration Update procedure to update UE capability information or to re-negotiate protocol parameters with the network, among others.

The AMF 321 may store one or more RM contexts for the UE 301, where each RM context is associated with a specific access to the network. The RM context may be a data structure, database object, etc. that indicates or stores, inter alia, a registration state per access type and the periodic update timer. The AMF 321 may also store a SGC MM context that may be the same or similar to the (E)MM context discussed previously. In various embodiments, the AMF 321 may store a CE mode B Restriction parameter of the UE 301 in an associated MM context or RM context The AMF 321 may also derive the value, when needed, from the UE's usage setting parameter already stored in the UE context (and/or MM/RM context).

CM may be used to establish and release a signaling connection between the UE 301 and the AMF 321 over the Nl interface. The signaling connection is used to enable NAS signaling exchange between the UE 301 and the CN 320, and comprises both the signaling connection between the UE and the AN (e.g., RRC connection or UE-N3IWF connection for non-3GPP access) and the N2 connection for the UE 301 between the AN (e.g., RAN 310) and the AMF 321. The UE 301 may operate in one of two CM states, CM-IDLE mode or CM-CONNECTED mode. When the UE 301 is operating in the CM-IDLE state/mode, the UE 301 may have no NAS signaling connection established with the AMF 321 over the Nl interface, and there may be (R)AN 310 signaling connection (e.g., N2 and/or N3 connections) for the UE 301. When the UE 301 is operating in the CM-CONNECTED state/mode, the UE 301 may have an established NAS signaling connection with the AMF 321 over the Nl interface, and there may be a (R)AN 310 signaling connection (e.g., N2 and/or N3 connections) for the UE 301. Establishment of an N2 connection between the (R)AN 310 and the AMF 321 may cause the UE 301 to transition from CM-IDLE mode to CM-CONNECTED mode, and the UE 301 may transition from the CM-CONNECTED mode to the CM-IDLE mode when N2 signaling between the (R)AN 310 and the AMF 321 is released.

The SMF 3 24 may be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 301 and a data network (DN) 303 identified by a Data Network Name (DNN). PDU sessions may be established upon UE 301 request, modified upon UE 301 and SGC 320 request, and released upon UE 301 and SGC 320 request using NAS SM signaling exchanged over the Nl reference point between the UE 301 and the SMF 324. Upon request from an application server, the SGC 320 may trigger a specific application in the UE 301. In response to receipt of the trigger message, the UE 301 may pass the trigger message (or relevant parts/information of the trigger message) to one or more identified applications in the UE 301. The identified application(s) in the UE 301 may establish a PDU session to a specific DNN. The SMF 324 may check whether the UE 301 requests are compliant with user subscription information associated with the UE 301. In this regard, the SMF 324 may retrieve and/or request to receive update notifications on SMF 324 level subscription data from the UDM 327.

The SMF 3 24 may include the following roaming functionality: handling local enforcement to apply QoS SLAs (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 324 may be included in the system 300, which may be between another SMF 324 in a visited network and the SMF 324 in the home network in roaming scenarios. Additionally, the SMF 324 may exhibit the Nsmf service-based interface.

The NEF 323 may provide means for securely exposing the services and capabilities provided by 3GPP network functions for third party, internal exposure/re-exposure, Application Functions (e.g., AF 328), edge computing or fog computing systems, etc. In such embodiments, the NEF 323 may authenticate, authorize, and/or throttle the AFs. NEF 323 may also translate information exchanged with the AF 328 and information exchanged with internal network functions. For example, the NEF 323 may translate between an AF-Service-Identifier and an internal SGC information. NEF 323 may also receive information from other network functions (NFs) based on exposed capabilities of other network functions. This information may be stored at the NEF 323 as structured data, or at a data storage NF using standardized interfaces. The stored information can then be re-exposed by the NEF 323 to other NFs and AFs, and/or used for other purposes such as analytics. Additionally, the NEF 32 3 may exhibit an Nnef service-based interface. The NRF 32 5 may support service discovery functions, receive NF discovery requests from NF instances, and provide the information of the discovered NF instances to the NF instances. NRF 325 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 325 may exhibit the Nnrf service-based interface.

The PCF 326 may provide policy rules to control plane function(s) to enforce them, and may also support unified policy framework to govern network behavior. The PCF 326 may also implement an FE to access subscription information relevant for policy decisions in a UDR of the UDM 327. The PCF 326 may communicate with the AMF 321 via an N15 reference point between the PCF 326 and the AMF 321, which may include a PCF 326 in a visited network and the AMF 321 in case of roaming scenarios. The PCF 326 may communicate with the AF 328 via an NS reference point between the PCF 326 and the AF 328; and with the SMF 324 via an N7 reference point between the PCF 326 and the SMF 324. The system 300 and/or CN 320 may also include an N24 reference point between the PCF 326 (in the home network) and a PCF 326 in a visited network. Additionally, the PCF 326 may exhibit an Npcf service-based interface. The UDM 327 may handle subscription-related information to support the network entities' handling of communication sessions, and may store subscription data of UE 301. For example, subscription data may be communicated between the UDM 327 and the AMF 321 via an NB reference point between the UDM 327 and the AMF. The UDM 327 may include two parts, an application FE and a UDR (the FE and UDR are not shown by FIG. 3). The UDR may store subscription data and policy data for the UDM 327 and the PCF 326, and/or structured data for exposure and application data (including PFDs for application detection, application request information for multiple UEs 301) for the NEF 323. The Nudr service-based interface may be exhibited by the UDR 221 to allow the UDM 327, PCF 326, and NEF 323 to access a particular set of the stored data, as well as to read, update (e.g., add, modify), delete, and subscribe to notification of relevant data changes in the UDR The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 324 via an N10 reference point between the UDM 327 and the SMF 324. UDM 327 may also support SMS management, wherein an SMS-

FE implements the similar application logic as discussed previously. Additionally, the UDM 327 may exhibit the Nudm service-based interface.

The AF 328 may provide application influence on traffic routing, provide access to the NCE, and interact with the policy framework for policy control. The NCE may be a mechanism that allows the SGC 320 and AF 328 to provide information to each other via NEF 323, which may be used for edge computing implementations. In such implementations, the network operator and third party services may be hosted close to the UE 3 01 access point of attachment to achieve an efficient service delivery through the reduced end-to-end latency and load on the transport network. For edge computing implementations, the SGC may select a UPF 302 close to the UE 301 and execute traffic steering from the UPF 302 to DN 303 via the N6 interface. This may be based on the UE subscription data, UE location, and information provided by the AF 328. In this way, the AF 328 may influence UPF (re)selection and traffic routing. Based on operator deployment, when AF 328 is considered to be a trusted entity, the network operator may permit AF 328 to interact directly with relevant NFs. Additionally, the AF 328 may exhibit an Naf service-based interface.

The NSSF 329 may select a set of network slice instances serving the UE 301. The NSSF 329 may also determine allowed NSSAI and the mapping to the subscribed S-NSSAis, if needed. The NSSF 329 may also determine the AMF set to be used to serve the UE 301, or a list of candidate AMF(s) 321 based on a suitable configuration and possibly by querying the NRF 325. The selection of a set of network slice instances for the UE 301 may be triggered by the AMF 321 with which the UE 301 is registered by interacting with the NSSF 329, which may lead to a change of AMF 321. The NSSF 329 may interact with the AMF 321 via an N22 reference point between AMF 321 and NSSF 329; and may communicate with another NSSF 329 in a visited network via an N31 reference point (not shown by FIG. 3). Additionally, the NSSF 3 29 may exhibit an Nnssf service-based interface.

As discussed previously, the CN 320 may include an SMSF, which may be responsible for SMS subscription checking and verification, and relaying SM messages to/from the UE 301 to/from other entities, such as an SMS-GMSC/IWMSC/SMS-router. The SMS may also interact with AMF 321 and UDM 327 for a notification procedure that the UE 301 is available for SMS transfer (e.g., set a UE not reachable flag, and notifying UDM 327 when UE 301 is available for SMS).

The CN 120 may also include other elements that are not shown by FIG. 3, such as a Data Storage system/architecture, a SG-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 3). Individual NFs may share a UDSF for storing their respective unstructured data or individual NFs may each have their own UDSF located at or near the individual NFs. Additionally, the UDSF may exhibit an Nudsf service-based interface (not shown by FIG. 3). The SG-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 3 for clarity. In one example, the CN 320 may include an Nx interface, which is an inter-CN interface between the MME (e.g., MME 221) and the AMF 321 in order to enable interworking between CN 320 and CN 220. Other example interfaces/reference points may include an NSg-EIR service-based interface exhibited by a SG-EIR, an N27 reference point between the NRF in the visited network and the NRF in the home network; and an N31 reference point between the NSSF in the visited network and the NSSF in the home network.

FIG. 4 illustrates an example of infrastructure equipment 400 in accordance with various embodiments. The infrastructure equipment 400 (or “system 400”) may be implemented as a base station, radio head, RAN node such as the RAN nodes 111 and/or AP 106 shown and described previously, application server(s) 130, and/or any other element/device discussed herein. In other examples, the system 400 could be implemented in or by a UE.

The system 400 includes application circuitry 405, baseband circuitry XSl10, one or more radio front end modules (RFEMs) 415, memory circuitry 420, power management integrated circuitry (PMIC) 425, power tee circuitry 430, network controller circuitry 435, network interface connector 440, satellite positioning circuitry 445, and user interface 450. In some embodiments, the device 400 may include additional elements such as, for example, memory/storage, display, camera, sensor, or input/output (1/0) interface. In other embodiments, the components described below may be included in more than one device. For example, said circuitries may be separately included in more than one device for CRAN, vBBU, or other like implementations. Application circuitry 405 includes circuitry such as, but not limited to one or more processors (or processor cores), cache memory, and one or more of low drop-out voltage regulators (LDOs), interrupt controllers, serial interfaces such as SPI, PC or universal programmable serial interface module, real time clock (RTC), timer-counters including interval and watchdog timers, general purpose input/output (1/0 or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 405 may be coupled with or may include memory/storage elements and may be configured to execute instructions stored in the memory/storage to enable various applications or operating systems to run on the system 400. In some implementations, the memory/storage elements may be on-chip memory circuitry, which may include any suitable volatile and/or non-volatile memory, such as DRAM, SRAM, EPROM, EEPROM, Flash memory, solid-state

memory, and/or any other type of memory device technology, such as those discussed herein.

The processor(s) of application circuitry 405 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 405 may comprise, or may be, a special-purpose processor/controller to operate according to the various embodiments herein. As examples, the processor(s) of application circuitry 405 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 400 may not utilize application circuitry 405, and instead may include a special-purpose processor/controller to process IP data received from an EPC or SGC, for example.

In some implementations, the application circuitry 4OS may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 405 may comprise logic blocks or logic fabric, and other interconnected resources that may be programmed to perform various functions, such as the procedures, methods, functions, etc. of the various embodiments discussed herein. In such embodiments, the circuitry of application circuitry 405 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like. The baseband circuitry 410 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 410 are discussed infra with regard to Figure

XT.

User interface circuitry 450 may include one or more user interfaces designed to enable user interaction with the system 400 or peripheral component interfaces designed to enable peripheral component interaction with the system 400. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

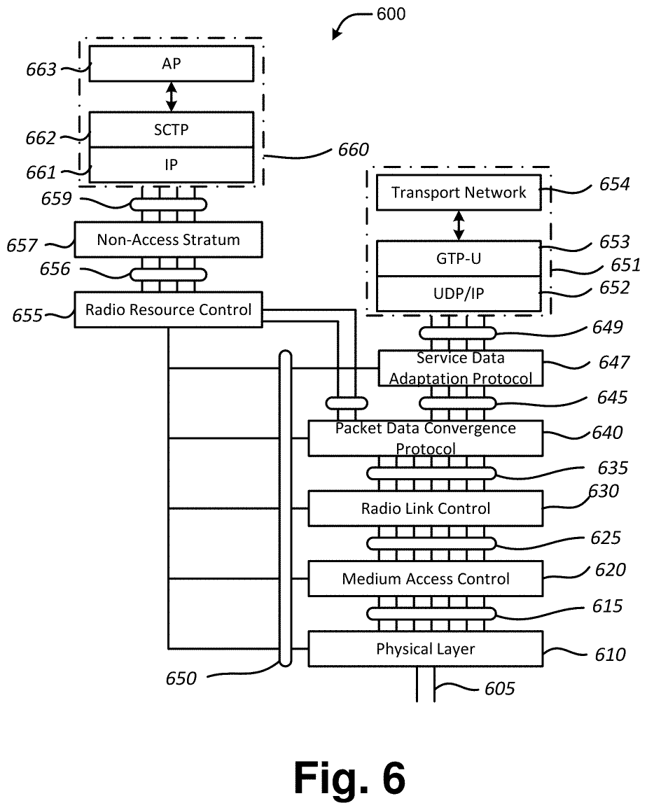

The radio front end modules (RFEMs) 415 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 5l11 of FIG. 6 infra), and the RFEM may be connected to multiple antennas. In alternative implementations, both mmWave and sub-mmWave radio functions may be implemented in the same physical RFEM 415, which incorporates both mmWave antennas and sub-mmWave.

The memory circuitry 420 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 420 may be implemented as one or more of solder down packaged integrated circuits, socketed memory modules and plug-in memory cards.

The PMIC 425 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 430 may provide for electrical power drawn from a network cable to provide both power supply and data connectivity to the infrastructure equipment 400 using a single cable.

The network controller circuitry 435 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 400 via network interface connector 440 using a physical connection, which may be electrical (commonly referred to as a “copper interconnect”), optical, or wireless. The network controller circuitry 435 may include one or more dedicated processors and/or FPGAs to communicate using one or more of the aforementioned protocols. In some implementations, the network controller circuitry 435 may include multiple controllers to provide connectivity to other networks using the same or different protocols.

The positioning circuitry 445 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 445 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 445 may include a Micro-Technology for Positioning, Navigation, and Timing (Micro-PNT) IC that uses a master timing clock to perform position tracking/estimation without GNSS assistance. The positioning circuitry 445 may also be part of, or interact with, the baseband circuitry XSl10 and/or RFEMs 415 to communicate with the nodes and components of the positioning network. The positioning circuitry 445 may also provide position data and/or time data to the application circuitry 4OS, which may use the data to synchronize operations with various infrastructure (e.g., RAN nodes 111, etc.), or the like.

The components shown by FIG. 4 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCix), PCI express (PCie), or any number of other technologies. The bus/IX may be a proprietary bus, for example, used in a SoC based system. Other bus/IX systems may be included, such as an PC interface, an SPI interface, point to point interfaces, and a power bus, among others.

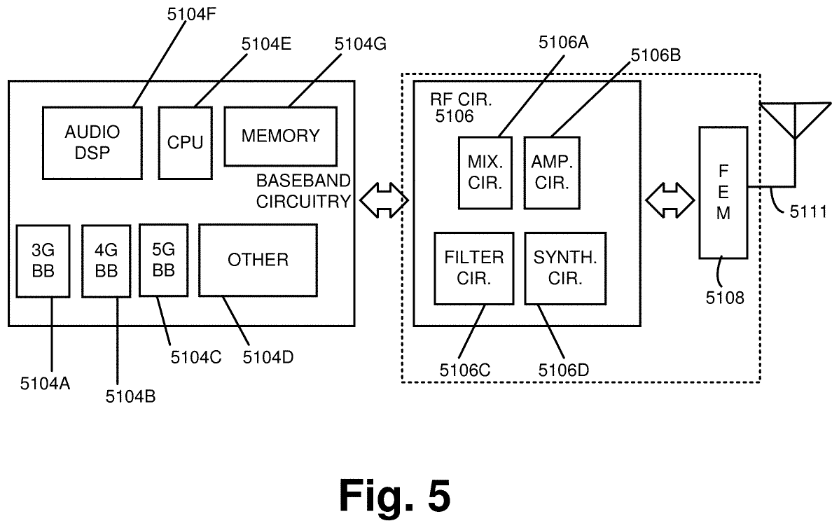

FIG. 5 illustrates an example of a platform 500 (or “device 500”) in accordance with various embodiments. In embodiments, the computer platform 500 may be suitable for use as UEs 101, 201, 301, application servers 130, and/or any other element/device discussed herein. The platform 500 may include any combinations of the components shown in the example. The components of platform 500 may be implemented as integrated circuits (ICs), portions thereof, discrete electronic devices, or other modules, logic, hardware, software, firmware, or a combination thereof adapted in the computer platform 500, or as components otherwise incorporated within a chassis of a larger system. The block diagram of FIG. 5 is intended to show a high level view of components of the computer platform 500. However, some of the components shown may be omitted, additional components may be present, and different arrangement of the components shown may occur in other implementations.

Application circuitry 505 includes circuitry such as, but not limited to one or more processors (or processor cores), cache memory, and one or more of LDOs, interrupt controllers, serial interfaces such as SPI, 12C or universal programmable serial interface module, RTC, timer-counters including interval and watchdog timers, general purpose If 0, memory card controllers such as SD MMC or similar, USB interfaces, MIPI interfaces, and JTAG test access ports. The processors (or cores) of the application circuitry 505 may be coupled with or may include memory/storage elements and may be configured to execute instructions stored in the memory/storage to enable various applications or operating systems to run on the system 500. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 405 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 405 may comprise, or may be, a special-purpose processor/controller to operate according to the various embodiments herein.

As examples, the processor(s) of application circuitry 505 may include an Intel® Architecture Core™ based processor, such as a Quark™, an Atom™, an i3, an iS, an i7, or an MCU-class processor, or another such processor available from Intel® Corporation, Santa Clara, Calif. The processors of the application circuitry 505 may also be one or more of Advanced Micro Devices (AMD) Ryzen® processor(s) or Accelerated Processing Units (APUs); AS-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 505 may be a part of a system on a chip (SoC) in which the application circuitry 505 and other components are formed into a single integrated circuit, or a single package, such as the Edison™ or Galileo™ SoC boards from Intel® Corporation.

Additionally or alternatively, application circuitry 505 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 505 may comprise logic blocks or logic fabric, and other interconnected resources that may be programmed to perform various functions, such as the procedures, methods, functions, etc. of the various embodiments discussed herein. In such embodiments, the circuitry of application circuitry 5 OS may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 510 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 510 are discussed infra with regard to FIG. 5.

The RFEMs 515 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 5l11 of FIG. 6 infra), and the RFEM may be connected to multiple antennas. In alternative implementations, both mmWave and sub-mmWave radio functions may be implemented in the same physical RFEM 515, which incorporates both mmWave antennas and sub-mmWave.

The memory circuitry 520 may include any number and type of memory devices used to provide for a given amount of system memory. As examples, the memory circuitry 5 20 may include one or more of volatile memory including random access memory (RAM), dynamic RAM (DRAM) and/or synchronous dynamic RAM (SD RAM), and nonvolatile memory (NVM) including high-speed electrically erasable memory (commonly referred to as Flash memory), phase change random access memory (PRAM), magnetoresistive random access memory (MRAM), etc. The memory circuitry 520 may be developed in accordance with a Joint Electron Devices Engineering Council (JEDEC) low power double data rate (LPDDR)-based design, such as LPDDR2, LPDDR3, LPDDR4, or the like. Memory circuitry 520 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 520 may be on-die memory or registers associated with the application circuitry 505. To provide for persistent storage of information such as data, applications, operating systems and so forth, memory circuitry 520 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 500 may incorporate the three-dimensional (3D) cross-point (XPOINT) memories from Intel® and Micron®.

Removable memory circuitry 523 may include devices, circuitry, enclosures/housings, ports or receptacles, etc. used to couple portable data storage devices with the platform 500. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 500 may also include interface circuitry (not shown) that is used to connect external devices with the platform 500. The external devices connected to the platform 500 via the interface circuitry include sensor circuitry 521 and electro-mechanical components (EMCs) 522, as well as removable memory devices coupled to removable memory circuitry 523.

The sensor circuitry 521 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 522 include devices, modules, or subsystems whose purpose is to enable platform 500 to change its state, position, and/or orientation, or move or control a mechanism or (sub)system. Additionally, EMCs 52 2 may be configured to generate and send messages/signaling to other components of the platform 500 to indicate a current state of the EMCs 522. Examples of the EMCs 522 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 500 is configured to operate one or more EMCs 522 based on one or more captured events and/or instructions or control signals received from a service provider and/or various clients. In some implementations, the interface circuitry may connect the platform 500 with positioning circuitry 545. The positioning circuitry 545 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 545 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 545 may include a Micro-PNT IC that uses a master timing clock to perform position tracking/estimation without GNSS assistance. The positioning circuitry 545 may also be part of, or interact with, the baseband circuitry 410 and/or RFEMs 515 to communicate with the nodes and components of the positioning network. The positioning circuitry 545 may also provide position data and/or time data to the application circuitry 505, which may use the data to synchronize operations with various infrastructure (e.g., radio base stations), for turn-by-turn navigation applications, or the like

In some implementations, the interface circuitry may connect the platform 500 with Near-Field Communication (NFC) circuitry 540. NFC circuitry 540 is configured to provide contactless, short-range communications based on radio frequency identification (RFID) standards, wherein magnetic field induction is used to enable communication between NFC circuitry 540 and NFC-enabled devices external to the platform 500 (e.g., an “NFC touchpoint”). NFC circuitry 540 comprises an NFC controller coupled with an antenna element and a processor coupled with the NFC controller. The NFC controller may be a chip/IC providing NFC functionalities to the NFC circuitry 540 by executing NFC controller firmware and an NFC stack The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 540, or initiate data transfer between the NFC circuitry 540 and another active NFC device (e.g., a smartphone or an NFC-enabled POS terminal) that is proximate to the platform 500.

The driver circuitry 546 may include software and hardware elements that operate to control particular devices that are embedded in the platform 500, attached to the platform 500, or otherwise communicatively coupled with the platform 500. The driver circuitry 546 may include individual drivers allowing other components of the platform 500 to interact with or control various input/output (1/0) devices that may be present within, or connected to, the platform 500. For example, driver circuitry 546 may include a display driver to control and allow access to a display device, a touchscreen driver to control and allow access to a touchscreen interface of the platform 500, sensor drivers to obtain sensor readings of sensor circuitry 521 and control and allow access to sensor circuitry 521, EMC drivers to obtain actuator positions of the EMCs 522 and/or control and allow access to the EMCs 522, a camera driver to control and allow access to an embedded image capture device, audio drivers to control and allow access to one or more audio devices.

The power management integrated circuitry (PMIC) 525 (also referred to as “power management circuitry 525”) may manage power provided to various components of the platform 500. In particular, with respect to the baseband circuitry 510, the PMIC 525 may control power-source selection, voltage scaling, battery charging, or DC-to-DC conversion. The PMIC 525 may often be included when the platform 500 is capable of being powered by a battery 530, for example, when the device is included in a UE 101, 201, 301.

In some embodiments, the PMIC 525 may control, or otherwise be part of, various power saving mechanisms of the platform 5 00. For example, if the platform 5 00 is in an RRC_Connected state, where it is still connected to the RAN node as it expects to receive traffic shortly, then it may enter a state known as Discontinuous Reception Mode (DRX) after a period of inactivity. During this state, the platform 500 may power down for brief intervals of time and thus save power. If there is no data traffic activity for an extended period of time, then the platform 500 may transition off to an RRC Idle state, where it disconnects from the network and does not perform operations such as channel quality feedback, handover, etc. The platform 5 00 goes into a very low power state and it performs paging where again it periodically wakes up to listen to the network and then powers down again. The platform 500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 530 may power the platform 500, although in some examples the platform 500 may be mounted deployed in a fixed location, and may have a power supply coupled to an electrical grid. The battery 530 may be a lithium ion battery, a metal-air battery, such as a zinc-air battery, an aluminum-air battery, a lithium-air battery, and the like. In some implementations, such as in V2X applications, the battery 530 may be a typical lead-acid automotive battery.

In some implementations, the battery 530 may be a “smart battery,” which includes or is coupled with a Battery Management System (BMS) or battery monitoring integrated circuitry. The BMS may be included in the platform 500 to track the state of charge (SoCh) of the battery 530. The BMS may be used to monitor other parameters of the battery 530 to provide failure predictions, such as the state of health (SoH) and the state of function (SoF) of the battery 530. The BMS may communicate the information of the battery 530 to the application circuitry 505 or other components of the platform 500. The BMS may also include an analog-to-digital (ADC) convertor that allows the application circuitry 505 to directly monitor the voltage of the battery 530 or the current flow from the battery 530. The battery parameters may be used to determine actions that the platform 500 may perform, such as transmission frequency, network operation, sensing frequency, and the like.

A power block, or other power supply coupled to an electrical grid may be coupled with the BMS to charge the battery 530. In some examples, the power block XS30 may be replaced with a wireless power receiver to obtain the power wirelessly, for example, through a loop antenna in the computer platform 500. In these examples, a wireless battery charging circuit may be included in the BMS. The specific charging circuits chosen may depend on the size of the battery 5 30, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 550 includes various input/output (1/0) devices present within, or connected to, the platform 500, and includes one or more user interfaces designed to enable user interaction with the platform 500 and/or peripheral component interfaces designed to enable peripheral component interaction with the platform 500. The user interface circuitry 550 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 500. The output device circuitry may also include speakers or other audio emitting devices, printer(s), and/or the like. In some embodiments, the sensor circuitry 521 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 500 may communicate with one another using a suitable bus or interconnect (IX) technology, which may include any number of technologies, including ISA, EISA, PCI, PCix, PCie, a Time-Trigger Protocol (TTP) system, a FlexRay system, or any number of other technologies. The bus/IX may be a proprietary bus/IX, for example, used in a SoC based system. Other bus/IX systems may be included, such as an 12C interface, an SPI interface, point-to-point interfaces, and a power bus, among others.

FIG. 5 illustrates example components of baseband circuitry 5110 and radio front end modules (RFEM) 5115 in accordance with various embodiments. The baseband circuitry 5110 corresponds to the baseband circuitry XSl10 and 510 of FIGS. 4 and 5, respectively. The RFEM 5115 corresponds to the RFEM 415 and 515 of FIGS. 4 and 5, respectively. As shown, the RFEMs 5115 may include Radio Frequency (RF) circuitry 5106, front-end module (FEM) circuitry 5108, antenna array 5111 coupled together at least as shown.

The baseband circuitry 5110 includes circuitry and/or control logic configured to carry out various radio/network protocol and radio control functions that enable communication with one or more radio networks via the RF circuitry 5106. The radio control functions may include, but are not limited to, signal modulation/demodulation, encoding/decoding, radio frequency shifting, etc. In some embodiments, modulation/demodulation circuitry of the baseband circuitry 5110 may include Fast-Fourier Transform (FFT), precoding, or constellation mapping/demapping functionality. In some embodiments, encoding/decoding circuitry of the baseband circuitry 5110 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 5110 is configured to process baseband signals received from a receive signal path of the RF circuitry 5106 and to generate baseband signals for a transmit signal path of the RF circuitry 5106. The baseband circuitry 5110 is configured to interface with application circuitry 405/505 (see FIGS. 4 and 5) for generation and processing of the baseband signals and for controlling operations of the RF circuitry 5106. The baseband circuitry 5110 may handle various radio control functions.

The aforementioned circuitry and/or control logic of the baseband circuitry 5110 may include one or more single or multi-core processors. For example, the one or more processors may include a 3G baseband processor 5104A, a 4G/LTE baseband processor 5104B, a SG/NR baseband processor 5104C, or some other baseband processor(s) 5104D for other existing generations, generations in development or to be developed in the future (e.g., sixth generation (6G), etc.). In other embodiments, some or all of the functionality of baseband processors 5104A-D may be included in modules stored in the memory 5104G and executed via a Central Processing Unit (CPU) 5104E. In other embodiments, some or all of the functionality of baseband processors 5104A-D may be provided as hardware accelerators (e.g., FPGAs, ASICs, etc.) loaded with the appropriate bit streams or logic blocks stored in respective memory cells. In various embodiments, the memory 5104G may store program code of a real-time OS (RTOS), which when executed by the CPU 5104E (or other baseband processor), is to cause the CPU 5104E (or other baseband processor) to manage resources of the baseband circuitry 5110, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 5110 includes one or more audio digital signal processor(s) (DSP) 5104F. The audio DSP(s) 5104F include elements for compression/decompression and echo cancellation and may include other suitable processing elements in other embodiments.

In some embodiments, each of the processors 5104A-XT104E include respective memory interfaces to send/receive data to/from the memory 5104G. The baseband circuitry 5110 may further include one or more interfaces to communicatively couple to other circuitries/devices, such as an interface to send/receive data to/from memory external to the baseband circuitry 5110; an application circuitry interface to send/receive data to/from the application circuitry 405/505 of FIGS. 4-XT); an RF circuitry interface to send/receive data to/from RF circuitry 5106 of FIG. 5; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from the PMIC 525.

In alternate embodiments (which may be combined with the above described embodiments), baseband circuitry 5110 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 5110 may include protocol processing circuitry with one or more instances of control circuitry (not shown) to provide control functions for the digital baseband circuitry and/or radio frequency circuitry (e.g., the radio front end modules 5115).

Although not shown by FIG. 5, in some embodiments, the baseband circuitry 5110 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or SG/NR protocol entities when the baseband circuitry 5110 and/or RF circuitry 5106 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 5110 and/or RF circuitry 5106 are part of a Wi-Fi communication system. In the second example, the protocol processing circuitry would operate Wi-Fi MAC and logical link control (LLC) functions. The protocol processing circuitry may include one or more memory structures (e.g., 5104G) to store program code and data for operating the protocol functions, as well as one or more processing cores to execute the program code and perform various operations using the data. The baseband circuitry 5110 may also support radio communications for more than one wireless protocol.

The various hardware elements of the baseband circuitry 5110 discussed herein may be implemented, for example, as a solder-down substrate including one or more integrated circuits (ICs), a single packaged IC soldered to a main circuit board or a multi-chip module containing two or more ICs. In one example, the components of the baseband circuitry 5110 may be suitably combined in a single chip or chipset, or disposed on a same circuit board. In another example, some or all of the constituent components of the baseband circuitry 5110 and RF circuitry 5106 may be implemented together such as, for example, a system on a chip (SoC) or System-in-Package (SiP). In another example, some or all of the constituent components of the baseband circuitry 5110 may be implemented as a separate SoC that is communicatively coupled with and RF circuitry 5106 (or multiple instances of RF circuitry 5106). In yet another example, some or all of the constituent components of the baseband circuitry 5110 and the application circuitry 405/5 OS may be implemented together as individual SoCs mounted to a same circuit board (e.g., a “multi-chip package”).

In some embodiments, the baseband circuitry 5110 may provide for communication compatible with one or more radio technologies. For example, in some embodiments, the baseband circuitry 5110 may support communication with an E-UTRAN or other WMAN, a WLAN, a WPAN. Embodiments in which the baseband circuitry 5110 is configured to support radio communications of more than one wireless protocol may be referred to as multi-mode baseband circuitry.

RF circuitry 5106 may enable communication with wireless networks using modulated electromagnetic radiation through a non-solid medium. In various embodiments, the RF circuitry 5106 may include switches, filters, amplifiers, etc. to facilitate the communication with the wireless network. RF circuitry 5106 may include a receive signal path, which may include circuitry to down-convert RF signals received from the FEM circuitry 5108 and provide baseband signals to the baseband circuitry 5110. RF circuitry 5106 may also include a transmit signal path, which may include circuitry to up-convert baseband signals provided by the baseband circuitry 5110 and provide RF output signals to the FEM circuitry 5108 for transmission.

In some embodiments, the receive signal path of the RF circuitry 5106 may include mixer circuitry 5106a, amplifier circuitry 5106b and filter circuitry 5106c. In some embodiments, the transmit signal path of the RF circuitry 5106 may include filter circuitry 5106c and mixer circuitry 5106a. RF circuitry 5106 may also include synthesizer circuitry 5106d for synthesizing a frequency for use by the mixer circuitry 5106a of the receive signal path and the transmit signal path. In some embodiments, the mixer circuitry 5106a of the receive signal path may be configured to down-convert RF signals received from the FEM circuitry 5108 based on the synthesized frequency provided by synthesizer circuitry 5106d. The amplifier circuitry 5106b may be configured to amplify the down-converted signals and the filter circuitry 5106c may be a low-pass filter (LPF) or band-pass filter (BPF) configured to remove unwanted signals from the down-converted signals to generate output baseband signals. Output baseband signals may be provided to the baseband circuitry 5110 for further processing. In some embodiments, the output baseband signals may be zero-frequency baseband signals, although this is not a requirement. In some embodiments, mixer circuitry 5106a of the receive signal path may comprise passive mixers, although the scope of the embodiments is not limited in this respect.

In some embodiments, the mixer circuitry 5106a of the transmit signal path may be configured to up-convert input baseband signals based on the synthesized frequency provided by the synthesizer circuitry 5106d to generate RF output signals for the FEM circuitry 5108. The baseband signals may be provided by the baseband circuitry 5110 and may be filtered by filter circuitry 5106c.

In some embodiments, the mixer circuitry 5106a of the receive signal path and the mixer circuitry 5106a of the transmit signal path may include two or more mixers and may be arranged for quadrature downconversion and upconversion, respectively. In some embodiments, the mixer circuitry 5106a of the receive signal path and the mixer circuitry 5106a of the transmit signal path may include two or more mixers and may be arranged for image rejection (e.g., Hartley image rejection). In some embodiments, the mixer circuitry 5106a of the receive signal path and the mixer circuitry 5106a of the transmit signal path may be arranged for direct downconversion and direct upconversion, respectively. In some embodiments, the mixer circuitry 5106a of the receive signal path and the mixer circuitry 5106a of the transmit signal path may be configured for super-heterodyne operation.

In some embodiments, the output baseband signals and the input baseband signals may be analog baseband signals, although the scope of the embodiments is not limited in this respect In some alternate embodiments, the output baseband signals and the input baseband signals may be digital baseband signals. In these alternate embodiments, the RF circuitry 5106 may include analog-to-digital converter (ADC) and digital-to-analog converter (DAC) circuitry and the baseband circuitry 5110 may include a digital baseband interface to communicate with the RF circuitry 5106.

In some dual-mode embodiments, a separate radio IC circuitry may be provided for processing signals for each spectrum, although the scope of the embodiments is not limited in this respect

In some embodiments, the synthesizer circuitry 5106d may be a fractional-N synthesizer or a fractional N/N+1 synthesizer, although the scope of the embodiments is not limited in this respect as other types of frequency synthesizers may be suitable. For example, synthesizer circuitry 5106d may be a delta-sigma synthesizer, a frequency multiplier, or a synthesizer comprising a phase-locked loop with a frequency divider.

The synthesizer circuitry 5106d may be configured to synthesize an output frequency for use by the mixer circuitry 5106a of the RF circuitry 5106 based on a frequency input and a divider control input In some embodiments, the synthesizer circuitry 5106d may be a fractional N/N+1 synthesizer.

In some embodiments, frequency input may be provided by a voltage controlled oscillator (VCO), although that is not a requirement Divider control input may be provided by either the baseband circuitry 5110 or the application circuitry 4OS/5 OS depending on the desired output frequency. In some embodiments, a divider control input (e.g., N) may be determined from a look-up table based on a channel indicated by the application circuitry 40S/50S.

Synthesizer circuitry 5106d of the RF circuitry 5106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either Nor N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 5106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 5106 may include an IQ/polar converter.

FEM circuitry 5108 may include a receive signal path, which may include circuitry configured to operate on RF signals received from antenna array 5l11, amplify the received signals and provide the amplified versions of the received signals to the RF circuitry 5106 for further processing. FEM circuitry 5108 may also include a transmit signal path, which may include circuitry configured to amplify signals for transmission provided by the RF circuitry 5106 for transmission by one or more of antenna elements of antenna array 5l11. In various embodiments, the amplification through the transmit or receive signal paths may be done solely in the RF circuitry 5106, solely in the FEM circuitry 5108, or in both the RF circuitry 5106 and the FEM circuitry 5108.

In some embodiments, the FEM circuitry 5108 may include a TX/RX switch to switch between transmit mode and receive mode operation. The FEM circuitry 5108 may include a receive signal path and a transmit signal path. The receive signal path of the FEM circuitry 5108 may include an LNA to amplify received RF signals and provide the amplified received RF signals as an output (e.g., to the RF circuitry 5106). The transmit signal path of the FEM circuitry 5108 may include a power amplifier (PA) to amplify input RF signals (e.g., provided by RF circuitry 5106), and one or more filters to generate RF signals for subsequent transmission by one or more antenna elements of the antenna array 5l11.

The antenna array 5l11 comprises one or more antenna elements, each of which is configured convert electrical signals into radio waves to travel through the air and to convert received radio waves into electrical signals. For example, digital baseband signals provided by the baseband circuitry 5110 is converted into analog RF signals (e.g., modulated waveform) that will be amplified and transmitted via the antenna elements of the antenna array 5l11 including one or more antenna elements (not shown). The antenna elements may be omnidirectional, direction, or a combination thereof. The antenna elements may be formed in a multitude of arranges as are known and/or discussed herein. The antenna array 5111 may comprise microstrip antennas or printed antennas that are fabricated on the surface of one or more printed circuit boards. The antenna array 5l11 may be formed in as a patch of metal foil (e.g., a patch antenna) in a variety of shapes, and may be coupled with the RF circuitry 5106 and/or FEM circuitry 5108 using metal transmission lines or the like.

Processors of the application circuitry 405/505 and processors of the baseband circuitry 5110 may be used to execute elements of one or more instances of a protocol stack For example, processors of the baseband circuitry 5110, alone or in combination, may be used execute Layer 3, Layer 2, or Layer 1 functionality, while processors of the application circuitry 405/505 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

FIG. 6 illustrates various protocol functions that may be implemented in a wireless communication device according to various embodiments. In particular, FIG. 6 includes an arrangement 600 showing interconnections between various protocol layers/entities. The following description of FIG. 6 is provided for various protocol layers/entities that operate in conjunction with the SG/NR system standards and LTE system standards, but some or all of the aspects of FIG. 6 may be applicable to other wireless communication network systems as well.

The protocol layers of arrangement XV00 may include one or more of PHY 610, MAC 620, RLC 630, PDCP 640, SDAP 647, RRC 655, and NAS layer 657, in addition to other higher layer functions not illustrated. The protocol layers may include one or more service access points (e.g., items 659, 656, 650, 649, 645, 635, 625, and 615 in FIG. 6) that may provide communication between two or more protocol layers.

The PHY 610 may transmit and receive physical layer signals 60S that may be received from or transmitted to one or more other communication devices. The physical layer signals 60S may comprise one or more physical channels, such as those discussed herein. The PHY 610 may further perform link adaptation or adaptive modulation and coding (AMC), power control, cell search (e.g., for initial synchronization and handover purposes), and other measurements used by higher layers, such as the RRC 655. The PHY 610 may still further perform error detection on the transport channels, forward error correction (FEC) coding/decoding of the transport channels, modulation/demodulation of physical channels, interleaving, rate matching, mapping onto physical channels, and MIMO antenna processing. In embodiments, an instance of PHY 610 may process requests from and provide indications to an instance of MAC 620 via one or more PHY-SAP 615. According to some embodiments, requests and indications communicated via PHY-SAP 615 may comprise one or more transport channels.

Instance(s) of MAC 620 may process requests from, and provide indications to, an instance of RLC 630 via one or more MAC-SAPs 625. These requests and indications communicated via the MAC-SAP 625 may comprise one or more logical channels. The MAC 620 may perform mapping between the logical channels and transport channels, multiplexing of MAC SDUs from one or more logical channels onto TBs to be delivered to PHY 610 via the transport channels, de-multiplexing MAC SDUs to one or more logical channels from TBs delivered from the PHY 610 via transport channels, multiplexing MAC SDUs onto TBs, scheduling information reporting, error correction through HARQ, and logical channel prioritization.

Instance(s) of RLC 630 may process requests from and provide indications to an instance of PDCP 640 via one or more radio link control service access points (RLC-SAP) 635. These requests and indications communicated via RLC-SAP 635 may comprise one or more RLC channels. The RLC 630 may operate in a plurality of modes of operation, including: Transparent Mode™, Unacknowledged Mode (UM), and Acknowledged Mode (AM). The RLC 630 may execute transfer of upper layer protocol data units (PD Us), error correction through automatic repeat request (ARQ) for AM data transfers, and concatenation, segmentation and reassembly of RLC SD Us for UM and AM data transfers. The RLC 630 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

Instance(s) of PDCP 640 may process requests from and provide indications to instance(s) of RRC 655 and/or instance(s) of SDAP 647 via one or more packet data convergence protocol service access points (PDCP-SAP) 645. These requests and indications communicated via PDCP-SAP 645 may comprise one or more radio bearers. The PDCP 640 may execute header compression and decompression of IP data, maintain PDCP Sequence Numbers (SNs), perform in-sequence delivery of upper layer PD Us at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

Instance(s) of SDAP 647 may process requests from and provide indications to one or more higher layer protocol entities via one or more SDAP-SAP 649. These requests and indications communicated via SDAP-SAP 649 may comprise one or more QoS flows. The SDAP 647 may map QoS flows to DRBs, and vice versa, and may also mark QFis in DL and UL packets. A single SDAP entity 647 may be configured for an individual PDU session. In the UL direction, the NG-RAN 110 may control the mapping of QoS Flows to DRB(s) in two different ways, reflective mapping or explicit mapping. For reflective mapping, the SDAP 647 of a UE 101 may monitor the QFis of the DL packets for each DRB, and may apply the same mapping for packets flowing in the UL direction. For a DRB, the SDAP 647 of the UE 101 may map the UL packets belonging to the QoS flows(s) corresponding to the QoS flow ID(s) and PDU session observed in the DL packets for that DRB. To enable reflective mapping, the NG-RAN 310 may mark DL packets over the Uu interface with a QoS flow ID. The explicit mapping may involve the RRC 655 configuring the SDAP 647 with an explicit QoS flow to DRB mapping rule, which may be stored and followed by the SDAP 647. In embodiments, the SDAP 647 may only be used in NR implementations and may not be used in LTE implementations.

The RRC 655 may configure, via one or more management service access points (M-SAP), aspects of one or more protocol layers, which may include one or more instances of PHY 610, MAC 620, RLC 630, PDCP 640 and SDAP 647. In embodiments, an instance of RRC 655 may process requests from and provide indications to one or more NAS entities 657 via one or more RRC-SAPs 656. The main services and functions of the RRC 65 5 may include broadcast of system information (e.g., included in MIBs or SIBs related to the NAS), broadcast of system information related to the access stratum (AS), paging, establishment, maintenance and release of an RRC connection between the UE 101 and RAN 110 (e.g., RRC connection paging, RRC connection establishment, RRC connection modification, and RRC connection release), establishment, configuration, maintenance and release of point to point Radio Bearers, security functions including key management, inter-RAT mobility, and measurement configuration for UE measurement reporting. The MIBs and SIBs may comprise one or more IEs, which may each comprise individual data fields or data structures.

The NAS 657 may form the highest stratum of the control plane between the UE 101 and the AMF 321. The NAS 657 may support the mobility of the UEs 101 and the session management procedures to establish and maintain IP connectivity between the UE 101 and a P-GW in LTE systems.

According to various embodiments, one or more protocol entities of arrangement 600 may be implemented in UEs 101, RAN nodes 111, AMF 321 in NR implementations or MME 221 in LTE implementations, UPF 302 in NR implementations or S-GW 222 and P-GW 223 in LTE implementations, or the like to be used for control plane or user plane communications protocol stack between the aforementioned devices. In such embodiments, one or more protocol entities that may be implemented in one or more of UE 101, gNB 111, AMF 321, etc. may communicate with a respective peer protocol entity that may be implemented in or on another device using the services of respective lower layer protocol entities to perform such communication. In some embodiments, a gNB-CU of the gNB 111 may host the RRC 655, SDAP 647, and PDCP 640 of the gNB that controls the operation of one or more gNB-DUs, and the gNB-DUs of the gNB 111 may each host the RLC 630, MAC 620, and PHY 610 of the gNB 111.

In a first example, a control plane protocol stack may comprise, in order from highest layer to lowest layer, NAS 657, RRC 655, PDCP 640, RLC 630, MAC 620, and PHY 610. In this

example, upper layers 660 may be built on top of the NAS 65 7, which includes an IP layer 661, an SCTP 662, and an application layer signaling protocol (AP) 663.

In NR implementations, the AP 663 may be an NG application protocol layer (NGAP or NG-AP) 663 for the NG interface 113 defined between the NG-RAN node 111 and the AMF 321, or the AP 663 may be an Xn application protocol layer (XnAP or Xn-AP) 663 for the Xn interface 112 that is defined between two or more RAN nodes 111.

The NG-AP 663 may support the functions of the NG interface 113 and may comprise Elementary Procedures (EPs). An NG-AP EP may be a unit of interaction between the NG-RAN node 111 and the AMF 321. The NG-AP 663 services may comprise two groups: DE-associated services (e.g., services related to a DE 101) and non-DE-associated services (e.g., services related to the whole NG interface instance between the NG-RAN node 111 and AMF 321). These services may include functions including, but not limited to: a paging function for the sending of paging requests to NG-RAN nodes 111 involved in a particular paging area; a DE context management function for allowing the AMF 321 to establish, modify, and/or release a DE context in the AMF 321 and the NG-RAN node 111; a mobility function for DEs 101 in ECM-CONNECTED mode for intra-system HOs to support mobility within NG-RAN and inter-system HOs to support mobility from/to EPS systems; a NAS Signaling Transport function for transporting or rerouting NAS messages between DE 101 and AMF 321; a NAS node selection function for determining an association between the AMF 321 and the DE 101; NG interface management function(s) for setting up the NG interface and monitoring for errors over the NG interface; a warning message transmission function for providing means to transfer warning messages via NG interface or cancel ongoing broadcast of warning messages; a Configuration Transfer function for requesting and transferring of RAN configuration information (e.g., SON information, performance measurement (PM) data, etc.) between two RAN nodes 111 via CN 120; and/or other like functions.

The XnAP 663 may support the functions of the Xn interface 112 and may comprise XnAP basic mobility procedures and XnAP global procedures. The XnAP basic mobility procedures may comprise procedures used to handle DE mobility within the NG RAN 111 (or E-DTRAN 210), such as handover preparation and cancellation procedures, SN Status Transfer procedures, DE context retrieval and DE context release procedures, RAN paging procedures, dual connectivity related procedures, and the like. The XnAP global procedures may comprise procedures that are not related to a specific DE 101, such as Xn interface setup and reset procedures, NG-RAN update procedures, cell activation procedures, and the like.

In LTE implementations, the AP 663 may be an Sl Application Protocol layer (Sl-AP) 663 for the Sl interface 113 defined between an E-DTRAN node 111 and an MME, or the AP 663 may be an X2 application protocol layer (X2AP or X2-AP) 663 for the X2 interface 112 that is defined between two or more E-DTRAN nodes 111.

The Sl Application Protocol layer (Sl-AP) 663 may support the functions of the Sl interface, and similar to the NG-AP discussed previously, the Sl-AP may comprise Sl-AP EPs. An Sl-AP EP may be a unit of interaction between the E-DTRAN node 111 and an MME 221 within an LTE CN 120.

The Sl-AP 663 services may comprise two groups: DE-associated services and non-DE-associated services. These services perform functions including, but not limited to: E-UTRAN Radio Access Bearer (E-RAB) management, UE capability indication, mobility, NAS signaling transport, RAN Information Management (RIM), and configuration transfer.

The X2AP 663 may support the functions of the X2 interface 112 and may comprise X2AP basic mobility procedures and X2AP global procedures. The X2AP basic mobility procedures may comprise procedures used to handle UE mobility within the E-UTRAN 120, such as handover preparation and cancellation procedures, SN Status Transfer procedures, UE context retrieval and UE context release procedures, RAN paging procedures, dual connectivity related procedures, and the like. The X2AP global procedures may comprise procedures that are not related to a specific UE 101, such as X2 interface setup and reset procedures, load indication procedures, error indication procedures, cell activation procedures, and the like.

The SCTP layer (alternatively referred to as the SCTP/IP layer) 662 may provide guaranteed delivery of application layer messages (e.g., NGAP or XnAP messages in NR implementations, or Sl-AP or X2AP messages in LTE implementations). The SCTP 662 may ensure reliable delivery of signaling messages between the RAN node 111 and the AMF 321/MME 221 based, in part, on the IP protocol, supported by the IP 661. The Internet Protocol layer (IP) 661 may be used to perform packet addressing and routing functionality. In some implementations the IP layer 661 may use point-to-point transmission to deliver and convey PDUs. In this regard, the RAN node 111 may comprise L2 and L1 layer communication links (e.g., wired or wireless) with the MME/AMF to exchange information.

In a second example, a user plane protocol stack may comprise, in order from highest layer to lowest layer, SDAP 647, PDCP 640, RLC 630, MAC 620, and PHY 610. The user plane protocol stack may be used for communication between the UE 101, the RAN node 111, and UPF 302 in NR implementations or an S-GW 222 and P-GW 223 in LTE implementations. In this example, upper layers 651 may be built on top of the SDAP 647, and may include a user datagram protocol (UDP) and IP security layer (UDP/IP) 652, a General Packet Radio Service (GPRS) Tunneling Protocol for the user plane layer (GTP-U) 653, and a User Plane PDU layer (UP PDU) 663.

The transport network layer 654 (also referred to as a “transport layer”) may be built on IP transport, and the GTP-U 653 may be used on top of the UDP/IP layer 652 (comprising a UDP layer and IP layer) to carry user plane PDUs (UP-PDUs). The IP layer (also referred to as the “Internet layer”) may be used to perform packet addressing and routing functionality. The IP layer may assign IP addresses to user data packets in any of IPv4, IPv6, or PPP formats, for example.

The GTP-U 653 may be used for carrying user data within the GPRS core network and between the radio access network and the core network. The user data transported can be packets in any of IPv4, IPv6, or PPP formats, for example. The UDP/IP 652 may provide checksums for data integrity, port numbers for addressing different functions at the source and destination, and encryption and authentication on the selected data flows. The RAN node 111 and the S-GW 222 may utilize an Sl-U interface to exchange user plane data via a protocol stack comprising an L1 layer (e.g., PHYXV10), an L2 layer (e.g., MAC 620, RLC 630, PDCP 640, and/or SDAP 647), the UDP/IP

layer 652, and the GTP-U 653. The S-GW 222 and the P-GW 223 may utilize an SS/S8a interface to exchange user plane data via a protocol stack comprising an L1 layer, an L2 layer, the UDP/IP layer 652, and the GTP-U 653. As discussed previously, NAS protocols may support the mobility of the UE 101 and the session management procedures to establish and maintain IP connectivity between the UE 101 and the P-GW 223.

Moreover, although not shown by FIG. 6, an application layer may be present above the AP 663 and/or the transport network layer 654. The application layer may be a layer in which a user of the UE 101, RAN node 111, or other network element interacts with software applications being executed, for example, by application circuitry 405 or application circuitry 505, respectively. The application layer may also provide one or more interfaces for software applications to interact with communications systems of the UE 101 or RAN node 111, such as the baseband circuitry 5110. In some implementations the IP layer and/or the application layer may provide the same or similar functionality as layers 5-7, or portions thereof, of the Open Systems Interconnection (OSI) model (e.g., OSI Layer 7—the application layer, OSI Layer 6—the presentation layer, and OSI Layer 5—the session layer).

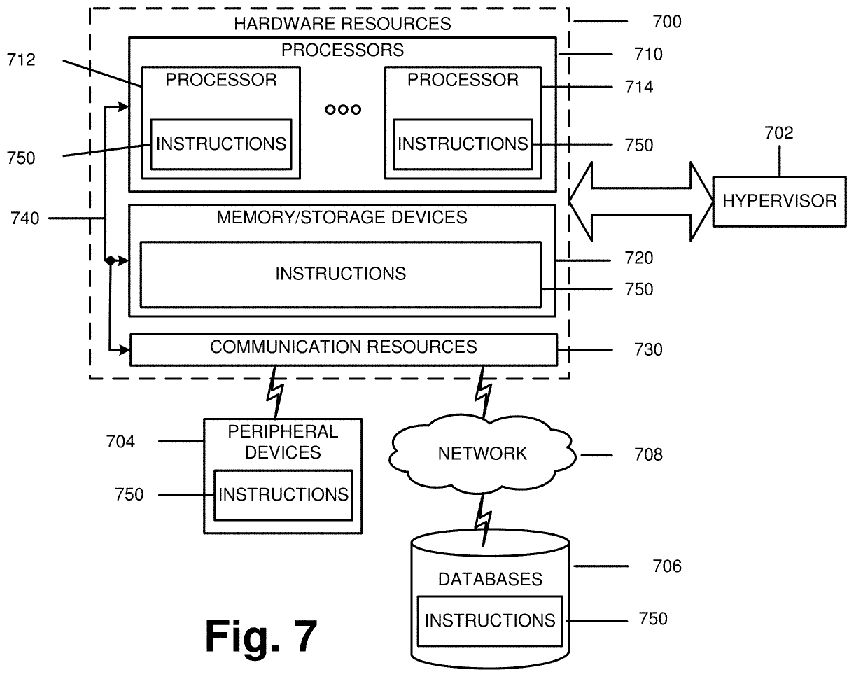

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714. The processor(s) 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile or nonvolatile memory such as dynamic random access memory (DRAM), static random access memory (SRAM), erasable programmable read-only memory (EPROM), electrically erasable programmable read-only memory (EE PROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via USB), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

Frame Structure Using Frame Based LBT:

In one embodiment, the gNB may operate as an initiating device, while its associated UEs may operate as the responding devices. In one embodiment, the gNB may perform clear channel assessment (CCA) using either CAT-1 or CAT-2 LBT (e.g. using one shot LBT). If the CCA succeeds, the gNB can start transmissions within a fixed frame period (FFP). Otherwise, the gNB drops the FFP, and does not attempt to perform any transmission. In this disclosure a FFP for which a gNB has succeeded LBT is defined as a valid FFP, and its DL slots are defined as valid DL slots.

In one embodiment, once the gNB succeeds with respect to CCA, it transmits for one or more consecutive slots if the DL transmissions are performed with a gap less than 16 μs. In one embodiment, if the gNB creates a gap larger than 16 μs, the gNB re-performs CCA, and based on whether CCA succeeds or fails, the gNB continues to operate within the FFP, or it drops any transmissions within that FFP.

In one embodiment, the first N symbols of the first slot within a FFP are always used for LBT independently of the frame configuration. In this case, the gNB transmission is postponed by N symbols. In one embodiment, N is chosen such that the number of N symbols covers at least 25 s.

In another embodiment, for the last DL or UL slot within a FFP, only the first Y OFDM symbols can be used for transmissions, while the last X are actually used to create the gNB LBT gap or idle period for the next fixed frame period. The number of X symbols represents at least the 5% of the COT. As an example, if the FFP=10 ms, then X>=0.5 ms.

In one embodiment, in order to reduce the implementation complexity, the FBE can be designed so that no LBT is needed at the UE. In this case the UL scheduling can be done such that the DL/UL gap is <16 μs. In such a case, according to one embodiment, the SLIVs within a FFP can be configured by the gNB so that no gaps exists between the end of a DL burst and the beginning of an UL burst. SLIV corresponds to the Start and Length Indicator Value for the time domain allocation for a physical downlink shared channel (PDSCH) or physical uplink shared channel (PUSCH). SLIV defines the start symbol and the number of consecutive symbols for PDSCH allocation. In another embodiment, it is up to the gNB to fill any gaps that might exist between a DL and the following UL burst In one embodiment, a UE operating as a responding device is required to perform CAT-2 LBT to acquire the channel conditionally, based on whether the UL burst belong to a valid or invalid FFP.

In another embodiment, depending on the gap X between the end of a DL burst and the beginning of the UL burst:
The UE performs CAT-1 LBT if X<=16 μs;
The UE performs CAT-2 LBT if X>16 μs.

The UE may perform CAT-1 or CAT-2, according to one embodiment, after it assesses whether a FFP is valid or not, where a valid FFP is defined as a FFP for which a gNB has been able to succeed in the LBT procedure

In one embodiment, a transmission within a FFP can always start with a DL burst, and end with an UL burst.

An example of the above provided in FIG. 8. In particular, FIG. 8 shows a FFP 800 including DL burst followed by a UL burst. There exists a LBT at the beginning of the FFP, followed by a DL burst, followed by an additional DL burst to generate a gap between the DL burst and the UL burst, followed by an UL burst, followed by an idle period.

In one embodiment, the length of the FFP is fixed, and as an example the FFP can align with a radio frame. In one embodiment, the FFP can be configurable, and it is up to gNB scheduling to make sure that the FFP is not modified more than once every 200 ms. In one embodiment, the FFP can be RRC signaled and chosen from a predefined set of values, as an example {2, 2.5, 5, 10 ms}, or {2, 5, 10 ms}.

In one embodiment, if the value of the FFP is set to be equal to 10 ms, then the FFP aligns with the radio frame. In one embodiment, the choice of the length of a FFP L is made so that its value is divisible by 10 ms (N*L=10 ms with N being an integer value). In this case, every N FFPs aligns with a radio frame. In one embodiment, the idle period can be fixed for every choice of the length of a FFP, and calculated based on the minimum requirements dictated by the regulation (e.g., the idle period is 5% of the COT, and must be always larger or equal to 100 μs). In another embodiment, the idle period can be configurable: in this case it is up to the gNB to choose a value which meets the regulatory requirements. In one embodiment, the idle period does not need to be indicated or configured, and it is up to the gNB to properly schedule DL and UL transmissions within the COT, such that a sufficient gap is left at the end of each FFP, which meets the requirements regarding the idle period. In one embodiment, given the radio frame boundary, the FFP starts in predefined starting positions, which are known by both the UE and the gNB. For instance, the length of the FFP and its starting position are defined such that the starting position of the first FFP is always aligned with the radio boundary, and the following FFPs periodically repeats every L ms: for example, if L=2 ms, then the starting position of the FFP within a radio frame is at the radio frame boundary Y, Y+2 ms, Y+4 ms, Y+6 ms and Y+8 ms.

In one embodiment, the starting position of the FFP can be any symbol within a slot or a frame, or any slot within a frame, and this may be indicated through an RRC signaling. The value indicated through RRC parameters is effectively an offset respect to the radio frame boundary, indicated here by A. The starting positions within the radio frame are evaluated by shifting of A every FFP of length L. In other words, within a radio frame, the starting positions are A+N*L, where N is integer value (0, 1, 2, . . . ), and the starting reference point is the radio frame boundary. In one embodiment, the starting position of the FFP is a new field in SIBx, which provides an offset value at the symbol level, and it is defined as follows:
FBEStartingOffset ENUMERATED {0,1,2,3,4,5,6,7,8,9,10,11,12,13} OPTIONAL, -- Need N

In one embodiment, the starting position of the FFP is a new field in SIBx, e.g. SIB1, which provides an offset value at the slot level, and it is defined as follows:
FBEStartingOffset ENUMERATED {0, . . . 9) OPTIONAL, -- Need N or
FEEStartingOffset ENUMERATED {0, . . . , 39) OPTIONAL, -- Need N

In one embodiment, the starting position of the FFP is a new field in SIBx, e.g. SIB1, which provides an offset value in terms of ms, and it is defined as follows:
FEEStartingOffset ENUMERATED {ms0, ms1, ms2, ms3, ms4, ms5, ms6, ms7, ms8, ms9} OPTIONAL, -- Need N

In one embodiment, the FFP length indication is a new parameter within the System Information Block (SIB) SIBx with x being an integer, e.g. SIB1, which if present implicitly indicates that the system will operate in FBE mode, while if this field is absent, this will indicate that the system will operate in LBE mode. As an example, this new field is defined as follows:
FFPLength ENUMERATED {2,5,10) OPTIONAL, -- Need N

In one embodiment, a SIBx, e.g. SIB1, parameter can be reinterpreted so as to carry information regarding the FFP length: for example, the field “tdd-UL-DL-ConfigurationCommon” can be used for this purpose. However, in this case an explicit indication of the mode of operation is needed, and a new field is required. As an example, this new field is defined as follows:
ModeOfOperation ENUMERATED {FBE, LBE} OPTIONAL, -- Need N

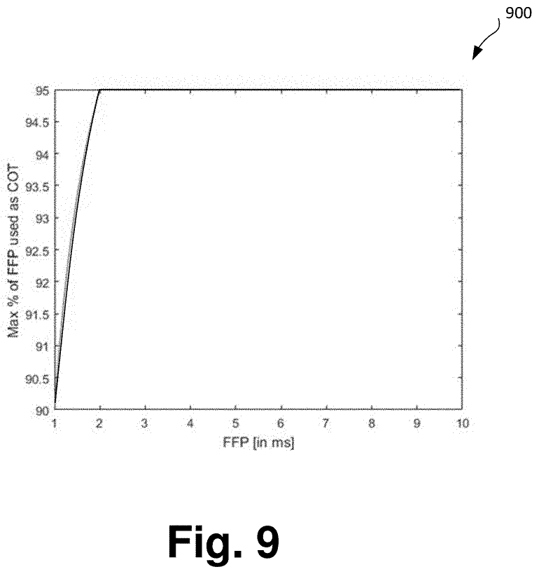

In one embodiment, the FFP is always larger than 2 ms and smaller than 10 ms. This is motivated by the fact that the ETSI BRAN mandates a minimum of 100 μs idle period at the end of each FFP, which greatly affects the spectral efficiency for FFP lesser than 2 ms as shown by FIG. 9.

Referring now to FIG. 9, a graph 900 is shown plotting FFP in ms versus the maximum percentage of FFP used as COT. Graph 900 shows that FFP between a duration of 2 ms and 10 ms represents 95% of FFP used as COT.

In one embodiment, no cross-FFP scheduling of UL transmission and HARQ-scheduling can be performed for the FBE design. In one embodiment, a configured grant is not enabled for the FBE design.

In one embodiment, for grant based UL transmissions, a UE always operates as a responding device, and it is not allowed to operate as an initiating device, since coordination among initiating devices may not be allowed by the regulatory bodies, and/or may cause mutual blocking among devices of the same technology. In one embodiment, the configured grant (CG) operation is only supported within the gNB's shared COT and within the gNB's FFP. A CG UE is allowed to transmit conditionally to the validity of the FFP. A CG UE is allowed to perform CCA and transmit given that a gNB has succeeded the CCA operation within that FFP.

In one embodiment. CG transmissions are allowed in FBE, and a UE follows the same FFP and starting position as that used an configured by the gNB. In one embodiment, a CG UE can operate both as responding and as an initiating device. In one embodiment when are UE operates in CG mode, it is allowed to operate as the initiating device. In one embodiment. When a UE operates in CG mode, it is allowed to choose autonomously its FFP length, and the starting position is aligned with the MT-Data-Request (TDR) and configured by the gNB. In this last case, according to one option, the UE may indicate the FFT length within the CG uplink control information (CG UCI) through the use of ⅔ bits.

In one embodiment, a UE may need to always assess whether a FFP is valid or not, where a valid FFP is defined as a FFP for which a gNB has been able to succeed in the LBT procedure. In one embodiment, a DCI may contain an additional bit field to indicate whether the LBT has succeeded or not. In one embodiment, this assessment can be done by detection of a DL signal such as the PDCCH/PDSCH DMRS signal for power saving purpose. In one embodiment, the detection of the DL demodulation reference signal (DMRS) can be performed within the last n slots before the start of the UL burst. In one embodiment, the DL slot prior to the UL burst can be used for presence detection of the DL burst, and is used to assess whether an UL burst can be initiated. In one embodiment, any DL slot prior to the UL burst can be used to perform DMRS presence detection of the DL burst, and is used to assess whether an UL burst can be initiated. In one embodiment, a UE assesses whether a FFP is valid or not, and it is allowed to perform UL transmission by performing presence detection on at least slots n−1 and n−2, where slot n is the first slot of the UL burst. In case a UE, assesses that a FFP is not valid, it drops the corresponding UL transmission.

In one embodiment, the UE assesses if a fixed frame period is valid (the gNB's LBT has succeeded) from the detection of the synchronization signal block (SSB (primary synchronization signal (PSS) and/or secondary synchronization signal (SSS)).

In one embodiment, the NR legacy physical random access channel (PRACH) is not allowed. In one embodiment, the PRACH is qualified as a short control signaling, meaning that the PRACH must comply with the following requirements:
Maximum of SO PRACH occasions over an observation period of SO ms;
PRACH uses at most 5% of the channel usage on an observation period of SO ms (2.5 ms).

In one embodiment, it is up to gNB to properly configure the PRACH so that the above requirements are met, by selecting the proper PRACH configuration index and format In one embodiment, only certain PRACH formats are allowed. In one embodiment, one or more of the following formats are used for FBE: format A1, format A2, format A3, format B1, format B2, format B3, format B4, format CO, format C2.

In one embodiment, the group-common physical downlink control channel (PDCCH) can contain an indication of the PRACH presence throughout a one bit field (or multiple bits), and it can serve as a grant for the PRACH transmissions. For example, “1” may indicate the presence of the PRACH inside the FFP, and “0” its absence, or vice versa. The group-common PDCCH can be transmitted in the beginning of the FFP if CCA is successful. The PRACH configuration can be separately provided to the UE by RRC signaling, or, the PRACH configuration can be provided to the UE together with the above indication by using the group-common PDCCH.

In one embodiment, the group-common PDCCH can contain indication of the configured grant presence throughout a one bit field (or multiple bits), and it can serve as a grant for the configured grant transmissions: for example, “1” indicates the presence of the configured grant inside the FFP, and “O” its absence, or vice versa. The group-common PDCCH can be transmitted in the beginning of the FFP if CCA is successful. The configured grant configuration can be separately provided to the UE by DE-specific RRC signaling. Additional configuration of configured grant can be provided to the UE together with the above indication by using the group-common PDCCH.

In one embodiment, a UE performs combining reception only over valid slots. In one embodiment, radio link monitoring (RLM) evaluation is performed only in valid FFPs.

In one embodiment, two modes of operation are defined for FBE: mode 1, which requires the design to comply with the regulatory requirements dictated by the ETSI BRAN; and mode 2, which do not require the system to be complaint with the regulatory requirements. When FBE operates according with mode 2, the legacy Rel. 15 NR design can be applied to FBE, and the UL channels such as PUCCH and PRACH do not require any interlaced design. In one embodiment, the mode of operation is either implicitly indicated by the frequency raster used, or explicitly indicated through RRC signaling or within the RMSI. In one embodiment, a UE is designed so that it can operated only in FBE or LBE mode, or in alternative a single UE is able to operate in both FBE and LBE mode. In this last case, the mode of operation is indicated explicitly through RRC signaling.

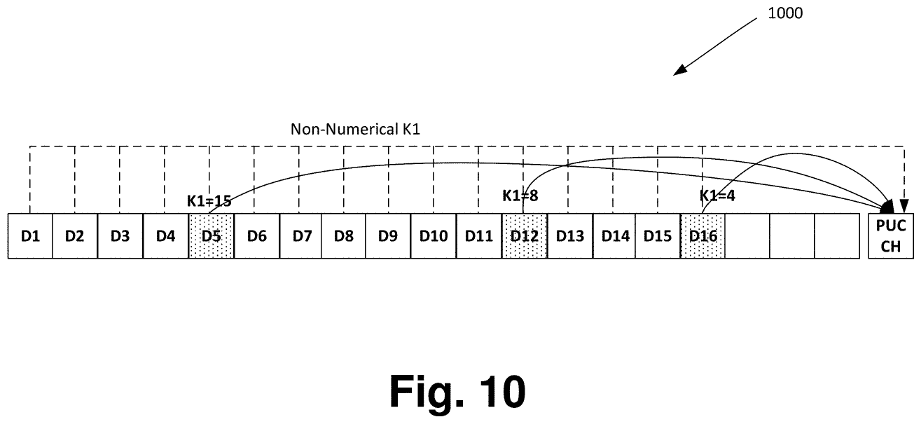

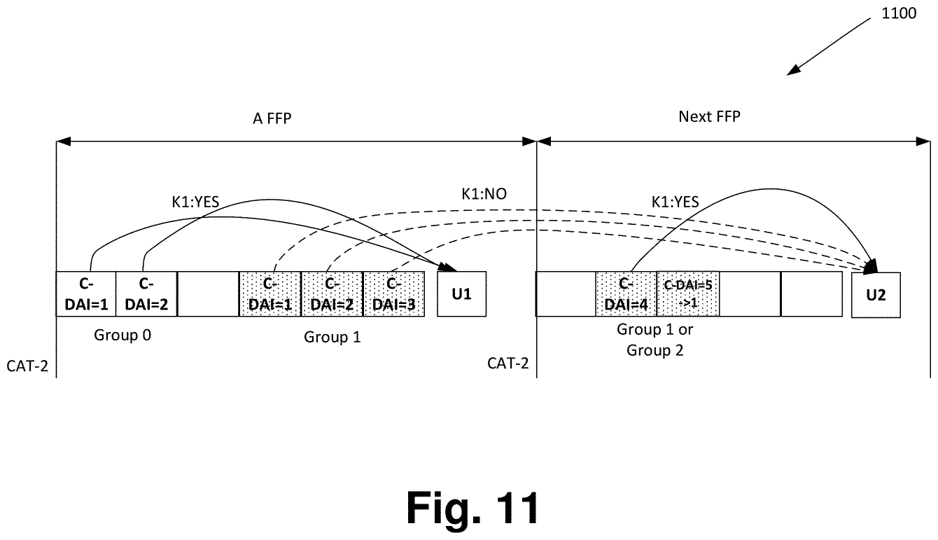

In one embodiment, if cross-FFP of UL transmissions and HARQ-scheduling is not supported then:
a. Legacy hybrid automatic repeat request (HARQ) procedure, or HARQ procedure for LBE, is reused and it is up to the gNB to properly configure the Kl and/or K2 values so that cross-FFP scheduling does not occur, with the value of Kl and/or K2 being linearly dependent on the FFP length.
b. Legacy HARQ procedure, or HARQ procedure for LBE is reused with the exception that the values of Kl and/or K2 are upper bounded so that regardless of the value chosen by the gNB, cross-FFP does not occur;
c. In one embodiment, the HARQ-acknowledgment (ACK) is always transmitted in a specific slot(s) of the FFP or in a specific slot(s) of each UL bursts within a valid FFP, for example the first slot of an UL burst. An example of this embodiment is shown in the transmissions 1000 of FIG. 10, where multiple DL transmissions D1-D16 in the time domain and a PUCCH carrying HARQ-ACK for D5, D12 and D16 are transmitted in the same FFP. In FIG. 10, the HARQ-ACK feedback is associated with a non-numerical Kl value which occur in this case at the end of the burst in the FFP. In this embodiment, the HARQ-ACK feedback will be applicable and valid only for those slots that meet the minimum processing time.
d. In one embodiment, each group of PDSCH transmissions is associated with a group index, and the gNB can assign different values to different groups at a different time. In one embodiment, as shown in the transmissions 1100 of FIG. 11, a gNB may trigger a HARQ-ACK transmission for the group (e.g. Group 1) of PDSCH transmissions (e.g. C-DAI 1-3 of Group 1) within the same FFP (e.g. the “next FFP” in FIG. 11), but also if needed it may trigger HARQ-ACK feedback for a previous group (e.g. Group 0) of PDSCHs (e.g. C-DAI 1-n of Group 0) that belongs to a different FFP (e.g. first FFP of FIG. 11) and/or within the same FFP. Since HARQ-ACK for the PDSCHs of Group 1 with C-DAI=1/2/3 cannot be scheduled within the FFP, non-numerical Kl could be used for the scheduling of the three Group 1 PDSCHs. In this way, PUCCH resource for HARQ-ACK transmission in the next FFP is not scheduled, e.g. no cross-FFP scheduling of PUCCH resource would occur. A group index=1 is thus assigned to the three PDSCHs with C-DAI=1/2/3 and two more PDSCHs with C-DAI=4/5 in the next FFP. A UE can then derive the PUCCH resource U2 for HARQ-ACK in the next FFP according to the DCI's scheduling PDSCHs with C-DAI=4/5. HARQ-ACKs for all 5 Group 1 PDSCHs are transmitted on U2, if the group of Group 0 PDSCH with C-DAI=1 and 2 fails in HARQ-ACK transmission in PUCCH resource U1. The DCIs scheduling PDSCHs with C-DAI=4/5 may indicate to the UE to report HARQ-ACKs for both Group 0 and Group 1, that is, HARQ-ACK for seven PDSCHs may be reported on U2.

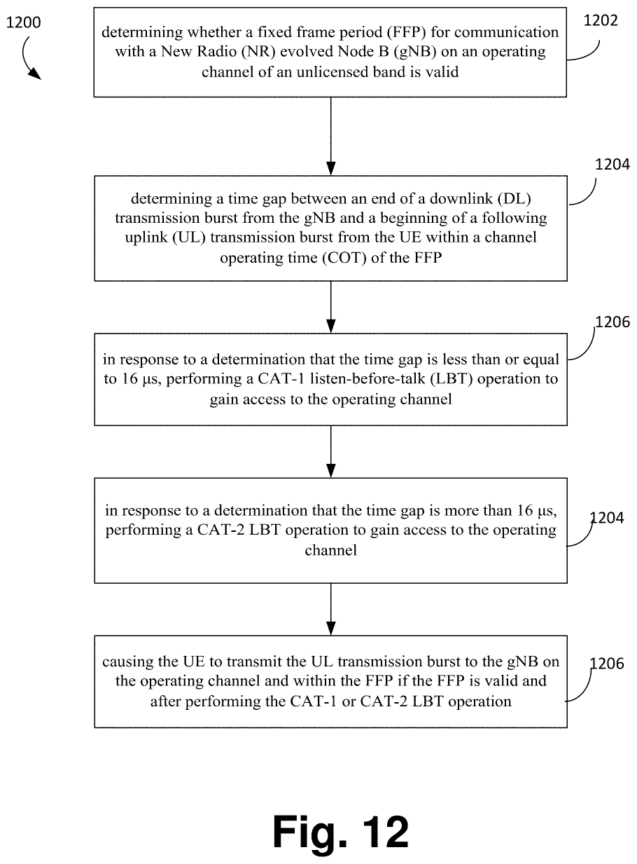

FIG. 12 shows a flow 1200 for a method to be performed at an apparatus of a UE. At operation 1202, the method includes determining whether a fixed frame period (FFP) for communication with a New Radio (NR) evolved Node B (gNB) on an operating channel of an unlicensed band is valid. At operation 1204, the method includes determining a time gap between an end of a downlink (DL) transmission burst from the gNB and a beginning of a following uplink (UL) transmission burst from the UE within a channel operating time (COT) of the FFP. At operation 1206, the method includes, in response to a determination that the time gap is less than or equal to 16 μs, performing a CAT-1 listen-before-talk (LBT) operation to gain access to the operating channel. At operation 1208, the method includes in response to a determination that the time gap is more than 16 μs, performing a CAT-2 LBT operation to gain access to the operating channel. At operation 1210, the method includes causing the UE to transmit the UL transmission burst to the gNB on the operating channel and within the FFP if the FFP is valid and after performing the CAT-1 or CAT-2 LBT operation.

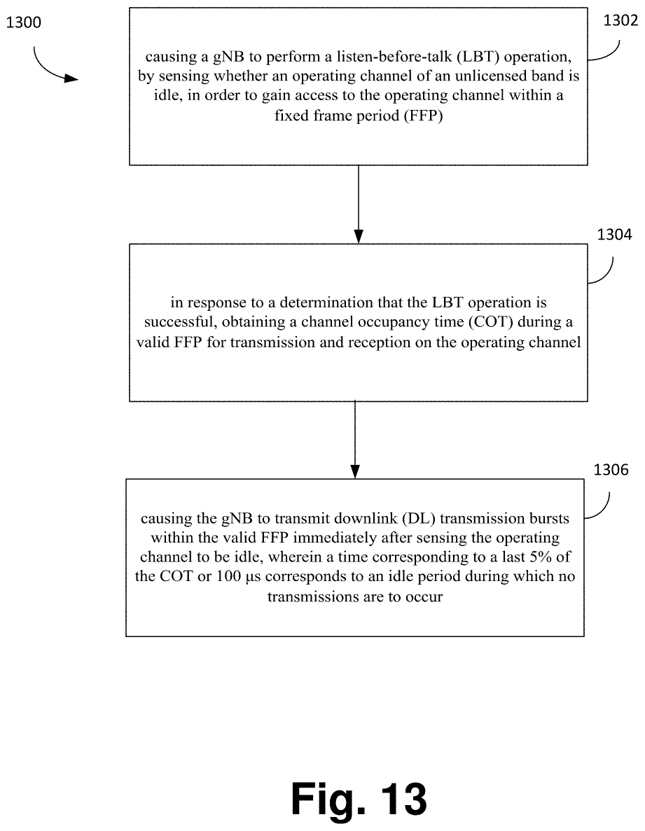

FIG. 13 shows a flow 1300 for a method to be performed at an apparatus of a gNB. At operation 1302, the method includes causing the gNB to perform a listen-before-talk (LBT) operation, by sensing whether an operating channel of an unlicensed band is idle, in order to gain access to the operating channel within a fixed frame period (FFP). At operation 1204, the method includes in response to a determination that the LBT operation is successful, obtaining a channel occupancy time (COT) during a valid FFP for transmission and reception on the operating channel. At operation 1306, the method includes causing the gNB to transmit downlink (DL) transmission bursts within the valid FFP immediately after sensing the operating channel to be idle, wherein a time corresponding to a last 5% of the COT or last 100 μs of the COT, which even is larger, corresponds to an idle period during which no transmissions are to occur.

In some embodiments, the electronic device(s), network(s), system(s), chip(s) or component(s), or portions or implementations thereof, of FIGS. 1-7, or some other figure herein, may be configured to perform one or more processes, techniques, or methods as described herein, or portions thereof. One such process is depicted in FIG. 12 or 13.

For one or more embodiments, at least one of the components set forth in one or more of the preceding Figures may be configured to perform one or more operations, techniques, processes, and/or methods as set forth in the example section below. For example, the baseband circuitry as described above in connection with one or more of the preceding Figures may be configured to operate in accordance with one or more of the examples set forth below. For another example, circuitry associated with a UE, base station, network element, etc. as described above in connection with one or more of the preceding Figures may be configured to operate in accordance with one or more of the examples set forth below in the example section.

### EXAMPLES

Example 1 includes an FBE design for NR operating on the unlicensed spectrum.

Example 2 includes the design of Example 1 or some other example herein, wherein the gNB will operate as an initiating device, while its associated UEs will operate as the responding devices.

Example 3 includes the design of Examples 1-2 or some other example herein, wherein the gNB performs CCA using either CAT-1 or CAT-2 LBT (one shot LBT). If the CCA successes, the eNB can start transmissions within the fixed frame period (FFP). Otherwise, the gNB drops the FFP, and does not attempt to perform any transmission.

Example 4 includes the design of Examples 1-3 or some other example herein, wherein once the gNB succeeds to perform CCA, it transmits for one or more consecutive slots, if the DL transmissions are performed with a gap less than 16 μs.

Example 5 includes the method of Example 1 or some other example herein, wherein if the gNB creates a gap larger than 16 μs, the gNB re-performs CCA, and based on whether this succeeds or fails, the gNB continues to operate within the FFP, or it drops any transmissions within that FFP.

Example 6 includes the design of Examples 1-5 or some other example herein, wherein the first N symbols of the first slot within a FFP are always used for LBT independently of the frame configuration. In this case, the gNB transmission is postponed of N symbols. In one embodiment, N is chosen such that the number of N symbols covers at least 25 μs.

Example 7 includes the design of Examples 1-5 or some other example herein, wherein, for the last DL or UL slot within a FFP only the first Y OFDM symbols can be used for transmissions, while the last X are actually used to create the gNB LBT gap or idle period for next fixed frame period. The number of X symbols represents at least the 5% of the COT. As an example if the FFP=10 ms, then X>=0.5 ms.

Example 8 includes the design of Examples 1-7 or some other example herein, wherein in order to reduce the implementation complexity, FBE can be designed so that no LBT is needed at the UE. In this case the UL scheduling can be done such that DL/UL gap is <16 μs. In this Example, the SLIVs within a FFP can be configured by the gNB so that no gaps exists between the end of a DL burst and the beginning of an UL burst. In another embodiment, it is up to gNB to fill any gaps that might exist between a DL and the following UL burst

Example 9 includes the design of Examples 1-8 or some other example herein, wherein depending on the gap X between the end of a DL burst and the beginning of the UL burst: the UE performs CAT-1 LBT if X<=16 μs; or the UE performs CAT-2 LBT if X>16 μs.

Example 10 includes the design of Examples 1-9 or some other example herein, wherein a transmission within a FFP can always start with a DL burst, and ends with an UL burst

Example 11 includes the design of Examples 1-10 or some other example herein, wherein the length of the FFP is fixed, and as an example the FFP can align with a radio frame. In this example, the FFP can be configurable, and it is up to gNB scheduling to make sure that the FFP is not modified more than once every 200 ms.

Example 12 includes the design of Examples 1-11 or some other example herein, wherein the FFP is always larger than 2 ms.

Example 13 includes the design of Examples 1-12 or some other example herein, wherein no cross-FFP scheduling of UL transmission and HARQ-scheduling can be performed for the FBE design.

Example 14 includes the design of Examples 1-13 or some other example herein, wherein configured grant (CG) is not enabled for the FBE design.

Example 15 includes the design of Examples 1-14 or some other example herein, wherein a UE may need to always assess whether a FFP is valid or not, where a valid FFP is defined as a FFP for which a gNB has been able to succeed the LBT procedure.

Example 16 includes the design of Examples 1-15 or some other example herein, wherein DCI may contain an additional bit field to indicate whether the LBT has succeeded or not

Example 17 includes the design of Examples 1-15 or some other example herein, wherein the assessment by the UE regarding whether a FFP is valid or not can be done by detection of a DL signal such as the PDCCH/PDSCH DMRS signal for power saving purposes.

Example 18 includes the design of Examples 1-15 or some other example herein, wherein the detection of the DL DMRS can be performed within the last n slots before the start of the UL burst

Example 19 includes the design of Examples 1-15 or some other example herein, wherein the DL slot prior to the UL burst can be used for presence detection of the DL burst, and is used to assess whether an UL burst can be initiated.

Example 20 includes the design of Examples 1-15 or some other example herein, wherein any DL slot prior to the UL burst can be used to perform DMRS presence detection of the DL burst, and is used to assess whether an UL burst can be initiated.

Example 21 includes the design of Examples 1-15 or some other example herein, wherein the UE assesses if a fixed frame period is valid (the gNB's LBT has succeeded) from the detection of the downlink reference signal (DRS) (PSS and/or SSS signal).

Example 22 includes the design of Examples 1-21 or some other example herein, wherein the NR legacy PRACH is not allowed.

Example 23 includes the design of Examples 1-22 or some other example herein, wherein the PRACH is qualified as a short control signaling.

Example 24 includes the design of Examples 1-23 or some other example herein, wherein it is up to the gNB to properly configure the PRACH so that the requirements to qualify as a short control signaling are met by selecting the proper PRACH configuration index and format.

Example 25 includes the design of Examples 1-23 or some other example herein, wherein only certain PRACH formats are allowed.

Example 26 includes the design of Examples 1-23 or some other example herein, wherein the group-common PDCCH can contain indication of the PRACH presence throughout a one bit field (or multiple bits), and it can serve as a grant for the PRACH transmissions. For example, “1” indicates the presence of the PRACH inside the FFP, and “0” its absence, or vice versa. The group-common PDCCH can be transmitted in the beginning of the FFP if CCA is successful. The PRACH configuration can be separately provided to the UE by RRC signaling. Or the PRACH configuration can be provided to the UE together with the above indication by using the group-common PDCCH.

Example 27 includes the design of Examples 1-26 or some other example herein, wherein the group-common PDCCH can contain an indication of the configured grant presence throughout a one bit field (or multiple bits), and it can serve as a grant for the configured grant transmissions: for example, “1” indicates the presence of the configured grant inside the FFP, and “0” its absence, or vice versa. The group-common PDCCH can be transmitted in the beginning of the FFP if CCA is successful. The configured grant configuration can be separately provided to the UE by UE-specific RRC signaling. Additional configuration of configured grant can be provided to the UE together with the above indication by using the group-common PDCCH.

Example 28 includes a method comprising: identifying a fixed frame period (FFP) as a valid FFP, with valid downlink slots, based on a gNB successfully performing a listen-before-talk (LBT) procedure.

Example 29 includes a method comprising: performing a presence detection on slots n−1 and n−2, where slot n is the first slot of an uplink burst; and determining whether an FFP is valid based on the presence detection.

Example 30 includes the method of Example 29 or some other example herein, wherein said determining comprises determining the FFP is not valid; and dropping, based on said determining, a corresponding uplink transmission.

Example 31 includes the method of Example 29 or some other example herein, further comprising combining reception only over slots of valid FFPs.

Example 32 includes the method of Example 29 or some other example herein, further comprising performing RLM evaluation only in valid FFPs.

Example 33 includes a method comprising: determining whether FBE is to operate according to mode 1, which requires compliance with regulatory requirements, or mode 2, which does not require compliance with the regulatory requirements.

Example 34 includes the method of Example 33 or some other example herein, wherein said determining comprises determining FBE is to operate according to mode 2 and the method further comprises applying a legacy release 15 NR design to FBE and utilizing UL channels (for example, PUCCH or PRACH) without interlacing.

Example 35 includes the method of Example 33 or some other example herein, further comprising determining whether FBE is to operate according to mode 1 or mode 2 based on an implicit indication based on a frequency raster that is used or an explicit indication based on RRC signaling or within an remaining minimum system information (RMSI).

Example 36 includes the method of Example 33-35, wherein a UE that implements the method is pre-configured to operate in FBE and not in LBE.

Example 37 includes a method comprising: determining that cross-FFP of uplink transmissions and HARQ scheduling is not supported; and operating, based on said determining, based on: reuse of legacy HARQ procedure or HARQ procedure for LBE, wherein a gNB is to configure Kl or K2 values so that cross-FFP scheduling does not occur, the Kl or K2 values being linearly dependent on the FFP length; reuse of legacy HARQ procedure or HARQ procedure for LBE except that values of Kl or K2 are upper bounded to prevent cross-FFP; transmission of HARQ ACK and specific slots of FFP or in specific slots of each UL burst within a valid FFP; or association of individual groups of PDSCH transmissions with group indices and assignment, by a gNB of different values to different groups at a different time.

Example 38 includes a method comprising: receiving an RRC message to indicate that a UE is to operate in FBE or LBE mode; and causing the UE to operate in the FBE or LBE mode based on the RRC message.

Example 39 includes a method comprising: receiving an indicator of a length of a fixed frame period (FFP) for frame-based listen before talk (LBT) communication, wherein the indicator is to identify that the FFP is one of a predefined set of values; and communicating or causing communication in the FFP based on the indicator.

Example 40 includes the method of Example 39 or some other example herein, wherein the indicator is received via radio resource control (RRC) signaling.

Example 41 includes the method of Example 39-40 or some other example herein, wherein the predefined set of values include one or more of 2, 2.5, 5, and/or 10 milliseconds (ms).

Example 42 includes the method of Example 39-41 or some other example herein, wherein the length of the FFP is 10 ms, and wherein the FFP aligns with a radio frame.

Example 43 includes the method of Example 39-42 or some other example herein, wherein the length of the FFP multiplied by an integer, N, is equal to 10 ms.

Example 44 includes the method of Example 43 or some other example herein, wherein every N FFPs align with a radio frame.

Example 45 includes the method of Example 39-44 or some other example herein, wherein an idle period of the FFP is the same for all of the predetermined set of values.

Example 46 includes the method of Example 45 or some other example herein, wherein the idle period length is 5% of a COT.

Example 47 includes the method of Example 45-46, wherein the idle period length is equal to or greater than 100 microseconds.

Example 48 includes the method of Example 39-47 or some other example herein, further comprising receiving an indication of an idle period length of the FFP.

Example 49 includes the method of Example 39-48 or some other example herein, wherein the FFP includes a downlink time period and an uplink time period.

Example 50 includes the method of Example 39-49 or some other example herein, wherein the method is performed by a UE or a portion thereof.

Example 51 includes the method of Example 50 or some other example herein, wherein the UE is a frame-based equipment (FBE) UE.

Example 52 includes a method comprising: determining a length of a fixed frame period (FFP) for frame-based listen before talk (LBT) communication, wherein the length of the FFP is one of a predefined set of values; and transmitting or causing to transmit an indicator of the length of the FFP to a UE.

Example 53 includes the method of Example 52 or some other example herein, wherein the indicator is transmitted via radio resource control (RRC) signaling.

Example 54 includes the method of Example 52-53 or some other example herein, wherein the predefined set of values include one or more of 2, 2.5, 5, and/or 10 milliseconds (ms).

Example 55 includes the method of Example 52-54 or some other example herein, wherein the length of the FFP is 10 ms, and wherein the method further comprises aligning the FFP with a radio frame.

Example 56 includes the method of Example 55 or some other example herein, further comprising transmitting or causing to transmit, to the UE, FFP configuration information to align the FFP with the radio frame.

Example 57 includes the method of Example 56 or some other example herein, wherein the FFP configuration information further includes the indicator of the length of the FFP.

Example 58 includes the method of Example 52-54 or some other example herein, wherein the length of the FFP multiplied by an integer, N, is equal to 10 ms.

Example 59 includes the method of Example 58 or some other example herein, wherein, for all of the predefined set of values for the length of the FFP, an integer multiple of the respective value is equal to a length of a radio frame (e.g., 10 ms).

Example 60 includes the method of Example 58 or some other example herein, further comprising aligning every N FFPs with a radio frame.

Example 61 includes the method of Example 60 or some other example herein, further comprising transmitting or causing to transmit, to the UE, FFP configuration information to align the every N FFPs with the radio frame.

Example 62 includes the method of Example 61 or some other example herein, wherein the FFP configuration information further includes the indicator of the length of the FFP.

Example 63 includes the method of Example 52-62 or some other example herein, wherein an idle period of the FFP is the same for all of the predetermined set of values.

Example 64 includes the method of Example 63 or some other example herein, wherein the idle period length is 5% of a COT.

Example 65 includes the method of Example 63-64 or some other example herein, wherein the idle period length is equal to or greater than 100 microseconds.

Example 66 includes the method of Example 52-62 or some other example herein, further comprising transmitting or causing to transmit, to the UE, an indication of an idle period length of the FFP.

Example 67 includes the method of Example 52-66 or some other example herein, wherein the FFP includes a downlink time period and an uplink time period.

Example 68 includes the method of Example 52-67 or some other example herein, wherein the UE is a frame-based equipment (FBE) UE.

Example 69 includes the method of Example 52-68 or some other example herein, wherein the method is performed by a gNB or a portion thereof.

Example 70 includes a method comprising: determining fixed frame periods (FFPs) for frame-based listen before talk (LBT) communication, wherein a length of the FFPs and their starting positions are defined such that a starting position of a first FFP is aligned with a radio boundary and following FFPs periodically repeat every L ms (where L is an integer, e.g., 2); and transmitting signals within the FFP.

Example 71 includes the method of Example 70 or some other example herein wherein starting positions of the FFPs can be any symbol within a slot or frame or any slot within a frame and are indicated through RRC signaling.

Example 72 includes the method of Example 70 or some other example herein, wherein starting positions of the FFPs are indicated in a SIBx message that provides an offset value at a slot level.

Example 73 includes the method of Example 70 or some other example herein, wherein a length of the FFPs is indicated in a field in a SIBx message, wherein absence of the field is to indicate that a system is to operate in LBE mode.

Example 74 includes the method of Example 70 or some other example herein, wherein a length of the FFPs is indicated in a field in a SIBx message and the SIBx message further includes a field to indicate a mode of operation (for example, FBE or LBE mode).

Example 75 includes an apparatus of a New Radio (NR) evolved Node B (gNB), the apparatus including a memory; and one or more processors coupled to the memory and configured to: cause the gNB to perform a listen-before-talk (LBT) operation, by sensing whether an operating channel of an unlicensed band is idle, in order to gain access to the operating channel within a fixed frame period (FFP); in response to a determination that the LBT operation is successful, obtain a channel occupancy time (COT) during a valid FFP for transmission and reception on the operating channel; and cause the gNB to transmit downlink (DL) transmission bursts within the valid FFP immediately after sensing the operating channel to be idle, wherein a time corresponding to a last 5% of the COT or 100 μs corresponds to an idle period during which no transmissions are to occur.

Example 76 includes the subject matter of Example 75, and optionally, the one or more processors to further, in response to a determination that the LBT operation is not successful, cause the gNB to drop any transmissions corresponding to an invalid FFP.

Example 77 includes the subject matter of Example 75, and optionally, wherein the one or more processors are to cause a transmission from the gNB to a user equipment (UE) of a configuration of the FFP.

Example 78 includes the subject matter of Example 77, and optionally, wherein the transmission of the configuration of the FFP includes a “tdd-UL-DL-ConfigurationCommon” field in a system information block (SIB) transmission to indicate a length of the FFP.

Example 79 includes the subject matter of Example 77, and optionally, wherein the one or more processors are to configure the FFP to correspond to a set of values including 2, 2.5, 5, and 10 ms.

Example 80 includes the subject matter of Example 77, and optionally, wherein the transmission of the configuration of the FFP is a system information block (SIB) transmission including a frame based equipment (FBE) starting offset value to indicate a starting position of the FFP.

Example 81 includes the subject matter of Example 75, and optionally, wherein the one or more processors are to cause a transmission from the gNB to a user equipment (UE) to indicate one of a frame-based equipment (FBE) or a load-based equipment (LBE) mode of operation, wherein the transmission to indicate one of a FBE or a LBE mode of operation includes a field in a system information block (SIB) transmission.

Example 82 includes the subject matter of Example 81, and optionally, where the field indicates a length of the FFP corresponding to a set of values including 2, 5 and 10.

Example 83 includes the subject matter of Example 75, and optionally, further including a Radio Frequency (RF) circuitry and one or more antennas coupled to the RF circuitry to transmit the DL transmission bursts.

Example 84 includes method to be performed at an apparatus of a New Radio (NR) evolved Node B (gNB), the method including: causing the gNB to perform a listen-before-talk (LBT) operation, by sensing whether an operating channel of an unlicensed band is idle, in order to gain access to the operating channel within a fixed frame period (FFP); in response to a determination that the LBT operation is successful, obtaining a channel occupancy time (COT) during a valid FFP for transmission and reception on the operating channel; and causing the gNB to transmit downlink (DL) transmission bursts within the valid FFP immediately after sensing the operating channel to be idle, wherein a time corresponding to a last 5% of the COT or 100 μs corresponds to an idle period during which no transmissions are to occur.

Example 85 includes the subject matter of Example 84, and optionally, further including, in response to a determination that the LBT operation is not successful, causing the gNB to drop any transmissions corresponding to an invalid FFP.

Example 86 includes the subject matter of Example 84, and optionally, further including causing a transmission from the gNB to a user equipment (UE) of a configuration of the FFP.

Example 87 includes the subject matter of Example 86, and optionally, wherein the transmission of the configuration of the FFP includes a “tdd-UL-DL-ConfigurationCommon” field in a system information block (SIB) transmission to indicate a length of the FFP.

Example 88 includes the subject matter of Example 86, and optionally, further including configuring the FFP to correspond to a set of values including 2, 2.5, 5, and 10 ms.

Example 89 includes the subject matter of Example 86, and optionally, wherein the transmission of the configuration of the FFP is a system information block (SIB) transmission including a frame based equipment (FBE) starting offset value to indicate a starting position of the FFP.

Example 90 includes the subject matter of Example 84, and optionally, further including causing a transmission from the gNB to a user equipment (UE) to indicate one of a frame-based equipment (FBE) or a load-based equipment (LBE) mode of operation, wherein the transmission to indicate one of a FBE or a LBE mode of operation includes a field in a system information block (SIB) transmission.

Example 91 includes the subject matter of Example 90, and optionally, wherein the field indicates a length of the FFP corresponding to a set of values including 2, 5 and 10.

Example 92 includes the subject matter of Example 84, and optionally, further including using a Radio Frequency (RF) circuitry and one or more antennas coupled to the RF circuitry to transmit the DL transmission bursts.

Example 93 includes one or more non-transitory computer-readable media comprising instructions to cause an apparatus of a New Radio (NR) evolved Node B (gNB), upon execution of the instructions by one or more processors of the apparatus, to perform operations including: causing the gNB to perform a listen-before-talk (LBT) operation, by sensing whether an operating channel of an unlicensed band is idle, in order to gain access to the operating channel within a fixed frame period (FFP); in response to a determination that the LBT operation is successful, obtaining a channel occupancy time (COT) during a valid FFP for transmission and reception on the operating channel; and causing the gNB to transmit downlink (DL) transmission bursts within the valid FFP immediately after sensing the operating channel to be idle, wherein a time corresponding to a last 5% of the COT or 100 μs corresponds to an idle period during which no transmissions are to occur.

Example 94 includes the subject matter of Example 19, and optionally, the operations further including, in response to a determination that the LBT operation is not successful, causing the gNB to drop any transmissions corresponding to an invalid FFP.

Example 95 includes the subject matter of Example 19, and optionally, the operations further including causing a transmission from the gNB to a user equipment (UE) of a configuration of the FFP.

Example 96 includes the subject matter of Example 21, and optionally, wherein the transmission of the configuration of the FFP includes a “tdd-UL-DL-ConfigurationCommon” field in a system information block (SIB) transmission to indicate a length of the FFP.

Example 97 includes the subject matter of Example 21, and optionally, the operations further including configuring the FFP to correspond to a set of values including 2, 2.5, 5, and 10 ms.

Example 98 includes the subject matter of Example 21, and optionally, wherein the transmission of the configuration of the FFP is a system information block (SIB) transmission including a frame based equipment (FBE) starting offset value to indicate a starting position of the FFP.

Example 99 includes the subject matter of Example 19, and optionally, the operations further including causing a transmission from the gNB to a user equipment (UE) to indicate one of a frame-based equipment (FBE) or a load-based equipment (LBE) mode of operation, wherein the transmission to indicate one of a FBE or a LBE mode of operation includes a field in a system information block (SIB) transmission.

Example 100 includes the subject matter of Example 25, and optionally, wherein the field indicates a length of the FFP corresponding to a set of values including 2, 5 and 10.

Example 101 includes the subject matter of Example 19, and optionally, the operations further including using a Radio Frequency (RF) circuitry and one or more antennas coupled to the RF circuitry to transmit the DL transmission bursts.

Example 102 includes an apparatus of a New Radio (NR) evolved Node B (gNB), the apparatus including: means for causing the gNB to perform a listen-before-talk (LBT) operation, by sensing whether an operating channel of an unlicensed band is idle, in order to gain access to the operating channel within a fixed frame period (FFP); means for, in response to a determination that the LBT operation is successful, obtaining a channel occupancy time (COT) during a valid FFP for transmission and reception on the operating channel; and means for causing the gNB to transmit downlink (DL) transmission bursts within the valid FFP immediately after sensing the operating channel to be idle, wherein a time corresponding to a last 5% of the COT or 100 μs corresponds to an idle period during which no transmissions are to occur.

Example 103 includes the subject matter of Example 102, and optionally, further including means for, in response to a determination that the LBT operation is not successful, causing the gNB to drop any transmissions corresponding to an invalid FFP.

Example 104 includes the subject matter of Example 102, and optionally, further including means for causing a transmission from the gNB to a user equipment (UE) of a configuration of the FFP.

Example 105 includes the subject matter of Example 104, and optionally, wherein the transmission of the configuration of the FFP includes a “tdd-UL-DL-ConfigurationCommon” field in a system information block (SIB) transmission to indicate a length of the FFP.

Example 106 includes the subject matter of Example 104, and optionally, further including means for configuring the FFP to correspond to a set of values including 2, 2.5, 5, and 10 ms.

Example 107 includes the subject matter of Example 104, and optionally, wherein the transmission of the configuration of the FFP is a system information block (SIB) transmission including a frame based equipment (FBE) starting offset value to indicate a starting position of the FFP.

Example 108 includes the subject matter of Example 102, and optionally, further including means for causing a transmission from the gNB to a user equipment (UE) to indicate one of a frame-based equipment (FBE) or a load-based equipment (LBE) mode of operation, wherein the transmission to indicate one of a FBE or a LBE mode of operation includes a field in a system information block (SIB) transmission.

Example 109 includes the subject matter of Example 108, and optionally, wherein the field indicates a length of the FFP corresponding to a set of values including 2, 5 and 10.

Example 110 includes the subject matter of Example 102, and optionally, further including means for using a Radio Frequency (RF) circuitry and one or more antennas coupled to the RF circuitry to transmit the DL transmission bursts.

Example 111 includes an apparatus of a User Equipment (UE), the apparatus including a memory; and one or more processors coupled to the memory and configured to: determine whether a fixed frame period (FFP) for communication with a New Radio (NR) evolved Node B (gNB) on an operating channel of an unlicensed band is valid; determine a time gap between an end of a downlink (DL) transmission burst from the gNB and a beginning of a following uplink (UL) transmission burst from the UE within a channel operating time (COT) of the FFP in response to a determination that the time gap is less than or equal to 16 μs, perform a CAT-1 listen-before-talk (LBT) operation to gain access to the operating channel; in response to a determination that the time gap is more than 16 μs, perform a CAT-2 LBT operation to gain access to the operating channel; and cause the UE to transmit the UL transmission burst to the gNB on the operating channel and within the FFP if the FFP is valid and after performing the CAT-1 or CAT-2 LBT operation.

Example 112 includes the subject matter of Example 111, and optionally, wherein the one or more processors are to perform the CAT-1 LBT operation or the CAT-2 LBT operation in response to a determination that the FFP is valid.

Example 113 includes the subject matter of Example 111, and optionally, wherein the one or more processors are to process a transmission from the gNB including an indication of a configuration of the FFP, and to determine the configuration from the transmission including the indication of a configuration of the FFP.

Example 114 includes the subject matter of Example 113, and optionally, wherein the transmission of the configuration of the FFP includes a “tdd-UL-DL-ConfigurationCommon” field in a system information block (SIB) transmission to indicate a length of the FFP.

Example 115 includes the subject matter of Example 113, and optionally, wherein the FFP corresponds to a set of values including 2, 2.5, 5, and 10 ms.

Example 116 includes the subject matter of Example 113, and optionally, wherein the transmission of the configuration of the FFP is a system information block (SIB) transmission including a frame based equipment (FBE) starting offset value to indicate a starting position of the FFP.

Example 117 includes the subject matter of Example 111, and optionally, wherein the one or more processors are to process a transmission from the gNB to indicate one of a frame-based equipment (FBE) or a load-based equipment (LBE) mode of operation, wherein the transmission to indicate one of a FBE or a LBE mode of operation includes a field in a system information block (SIB) transmission.

Example 118 includes the subject matter of Example 117, and optionally, where the field indicates a length of the FFP corresponding to a set of values including 2, 5 and 10.

Example 119 includes the subject matter of Example 111, and optionally, further including a Radio Frequency (RF) circuitry and one or more antennas coupled to the RF circuitry to transmit the UL transmission burst.

Example 120 includes a method to be performed at an apparatus of a User Equipment (UE), the method including: determining whether a fixed frame period (FFP) for communication with a New Radio (NR) evolved Node B (gNB) on an operating channel of an unlicensed band is valid; determining a time gap between an end of a downlink (DL) transmission burst from the gNB and a beginning of a following uplink (UL) transmission burst from the UE within a channel operating time (COT) of the FFP; in response to a determination that the time gap is less than or equal to 16 μs, performing a CAT-1 listen-before-talk (LBT) operation to gain access to the operating channel; in response to a determination that the time gap is more than 16 μs, performing a CAT-2 LBT operation to gain access to the operating channel; and causing the UE to transmit the UL transmission burst to the gNB on the operating channel and within the FFP if the FFP is valid and after performing the CAT-1 or CAT-2 LBT operation.

Example 121 includes the subject matter of Example 120, and optionally, further including performing the CAT-1 LBT operation or the CAT-2 LBT operation in response to a determination that the FFP is valid.

Example 122 includes the subject matter of Example 120, and optionally, further including processing a transmission from the gNB including an indication of a configuration of the FFP, and determining the configuration from the transmission including the indication of a configuration of the FFP.

Example 123 includes the subject matter of Example 122, and optionally, wherein the transmission of the configuration of the FFP includes a “tdd-UL-DL-ConfigurationCommon” field in a system information block (SIB) transmission to indicate a length of the FFP.

Example 124 includes the subject matter of Example 122, and optionally, wherein the FFP corresponds to a set of values including 2, 2.5, 5, and 10 ms.

Example 125 includes the subject matter of Example 122, and optionally, wherein the transmission of the configuration of the FFP is a system information block (SIB) transmission including a frame based equipment (FBE) starting offset value to indicate a starting position of the FFP.

Example 126 includes the subject matter of Example 124, and optionally, further including processing a transmission from the gNB to indicate one of a frame-based equipment (FBE) or a load-based equipment (LBE) mode of operation, wherein the transmission to indicate one of a FBE or a LBE mode of operation includes a field in a system information block (SIB) transmission.

Example 127 includes the subject matter of Example 126, and optionally, where the field indicates a length of the FFP corresponding to a set of values including 2, 5 and 10.

Example 128 includes the subject matter of Example 120, and optionally, further including using a Radio Frequency (RF) circuitry and one or more antennas coupled to the RF circuitry to transmit the UL transmission burst.

Example 129 includes one or more non-transitory computer-readable media comprising instructions to cause an apparatus of a User Equipment (UE), upon execution of the instructions by one or more processors of the apparatus, to perform operations including: determining whether a fixed frame period (FFP) for communication with a New Radio (NR) evolved Node B (gNB) on an operating channel of an unlicensed band is valid; determining a time gap between an end of a downlink (DL) transmission burst from the gNB and a beginning of a following uplink (UL) transmission burst from the UE within a channel operating time (COT) of the FFP; in response to a determination that the time gap is less than or equal to 16 μs, performing a CAT-1 listen-before-talk (LBT) operation to gain access to the operating channel; in response to a determination that the time gap is more than 16 μs, performing a CAT-2 LBT operation to gain access to the operating channel; and causing the UE to transmit the UL transmission burst to the gNB on the operating channel and within the FFP if the FFP is valid and after performing the CAT-1 or CAT-2 LBT operation.

Example 130 includes the subject matter of Example 129, and optionally, the operations further including performing the CAT-1 LBT operation or the CAT-2 LBT operation in response to a determination that the FFP is valid.

Example 131 includes the subject matter of Example 129, and optionally, the operations further including processing a transmission from the gNB including an indication of a configuration of the FFP, and determining the configuration from the transmission including the indication of a configuration of the FFP.

Example 132 includes the subject matter of Example 131, and optionally, wherein the transmission of the configuration of the FFP includes a “tdd-UL-DL-ConfigurationCommon” field in a system information block (SIB) transmission to indicate a length of the FFP.

Example 133 includes the subject matter of Example 131, and optionally, wherein the FFP corresponds to a set of values including 2, 2.5, 5, and 10 ms.

Example 134 includes the subject matter of Example 131, and optionally, wherein the transmission of the configuration of the FFP is a system information block (SIB) transmission including a frame based equipment (FBE) starting offset value to indicate a starting position of the FFP.

Example 135 includes the subject matter of Example 129, and optionally, the operations further including processing a transmission from the gNB to indicate one of a frame-based equipment (FBE) or a load-based equipment (LBE) mode of operation, wherein the transmission to indicate one of a FBE or a LBE mode of operation includes a field in a system information block (SIB) transmission.

Example 136 includes the subject matter of Example 133, and optionally, where the field indicates a length of the FFP corresponding to a set of values including 2, 5 and 10.

Example 137 includes the subject matter of Example 129, and optionally, further including using a Radio Frequency (RF) circuitry and one or more antennas coupled to the RF circuitry to transmit the UL transmission burst.

Example 138 includes an apparatus comprising means to perform one or more elements of a method described in or related to any of the Examples above, or any other method or process described herein.

Example 139 includes one or more non-transitory computer-readable media comprising instructions to cause an electronic device, upon execution of the instructions by one or more processors of the electronic device, to perform one or more elements of a method described in or related to any of the Examples above, or any other method or process described herein.

Example 140 includes an apparatus comprising logic, modules, or circuitry to perform one or more elements of a method described in or related to any of the Examples above, or any other method or process described herein.

Example 141 includes a method, technique, or process as described in or related to any of the Examples above, or portions or parts thereof

Example 142 includes an apparatus comprising: one or more processors and one or more computer-readable media comprising instructions that, when executed by the one or more processors, cause the one or more processors to perform the method, techniques, or process as described in or related to any of the Examples above, or portions thereof.

Example 143 includes a signal as described in or related to any of the Examples above, or portions or parts thereof

Example 144 includes a datagram, packet, frame, segment, protocol data unit (PDU), or message as described in or related to any of the Examples above, or portions or parts thereof, or otherwise described in the present disclosure.

Example 145 includes a signal encoded with data as described in or related to any of the Examples above, or portions or parts thereof, or otherwise described in the present disclosure.

Example 146 includes a signal encoded with a datagram, packet, frame, segment, protocol data unit (PDU), or message as described in or related to any of the Examples above, or portions or parts thereof, or otherwise described in the present disclosure.

Example 147 includes an electromagnetic signal carrying computer-readable instructions, wherein execution of the computer-readable instructions by one or more processors is to cause the one or more processors to perform the method, techniques, or process as described in or related to any of the Examples above, or portions thereof

Example 148 1 includes a computer program comprising instructions, wherein execution of the program by a processing element is to cause the processing element to carry out the method, techniques, or process as described in or related to any of the Examples above, or portions thereof.

Example 149 includes a signal in a wireless network as shown and described herein.

Example 150 includes a method of communicating in a wireless network as shown and described herein.

Example 151 includes a system for providing wireless communication as shown and described herein.

Example 152 includes a device for providing wireless communication as shown and described herein.

Any of the above-described examples may be combined with any other example (or combination of Examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. An apparatus of a User Equipment (UE), the apparatus including a memory; and one or more processors coupled to the memory and configured to:
determine whether a fixed frame period (FFP) for communication with a New Radio (NR) evolved Node B (gNB) on an operating channel of an unlicensed band is valid;
determine a time gap between an end of a downlink (DL) transmission burst from the gNB and a beginning of a following uplink (UL) transmission burst from the UE within a channel operating time (COT) of the FFP;
in response to a determination that the time gap is less than or equal to 16 μs, perform a CAT-1 listen-before-talk (LBT) operation to gain access to the operating channel;
in response to a determination that the time gap is more than 16 μs, perform a CAT-2 LBT operation to gain access to the operating channel; and
cause the UE to transmit the UL transmission burst to the gNB on the operating channel and within the FFP if the FFP is valid and after performing the CAT-1 or CAT-2 LBT operation.

2. The apparatus of claim 1, wherein the one or more processors are to perform the CAT-1 LBT operation or the CAT-2 LBT operation in response to a determination that the FFP is valid.

3. The apparatus of claim 1, wherein a time corresponding to a last 5% of the COT or 100 μs corresponds to an idle period during which no transmissions are to occur.

4. The apparatus of claim 1, wherein the one or more processors are to process a transmission from the gNB including an indication of a configuration of the FFP, and to determine the configuration from the transmission including the indication of a configuration of the FFP.

5. The apparatus of claim 4, wherein the transmission of the configuration of the FFP includes a “tdd-UL-DL-ConfigurationCommon” field in a system information block (SIB) transmission to indicate a length of the FFP.

6. The apparatus of claim 4, wherein the FFP corresponds to a set of values including 2, 2.5, 5, and 10 ms.

7. The apparatus of claim 4, wherein the transmission of the configuration of the FFP is a system information block (SIB) transmission including a frame based equipment (FBE) starting offset value to indicate a starting position of the FFP.

8. The apparatus of claim 1, wherein the one or more processors are to process a transmission from the gNB to indicate one of a frame-based equipment (FBE) or a load-based equipment (LBE) mode of operation, wherein the transmission to indicate one of a FBE or a LBE mode of operation includes a field in a system information block (SIB) transmission.

9. The apparatus of claim 8, where the field indicates a length of the FFP corresponding to a set of values including 2, 5 and 10.

10. The apparatus of claim 1, wherein a starting position of the FFP is to align with a boundary of a radio frame for communication in the operating channel.

11. The apparatus of claim 1, further including a Radio Frequency (RF) circuitry and one or more antennas coupled to the RF circuitry to transmit the UL transmission burst.

12. A method to be performed at an apparatus of a User Equipment (UE), the method including:
determining whether a fixed frame period (FFP) for communication with a New Radio (NR) evolved Node B (gNB) on an operating channel of an unlicensed band is valid;
determining a time gap between an end of a downlink (DL) transmission burst from the gNB and a beginning of a following uplink (UL) transmission burst from the UE within a channel operating time (COT) of the FFP;
in response to a determination that the time gap is less than or equal to 16 μs, performing a CAT-1 listen-before-talk (LBT) operation to gain access to the operating channel;
in response to a determination that the time gap is more than 16 μs, performing a CAT-2 LBT operation to gain access to the operating channel; and
causing the UE to transmit the UL transmission burst to the gNB on the operating channel and within the FFP if the FFP is valid and after performing the CAT-1 or CAT-2 LBT operation.

13. The method of claim 12, wherein a time corresponding to a last 5% of the COT or 100 μs corresponds to an idle period during which no transmissions are to occur.

14. The method of claim 12, further including processing a transmission from the gNB including an indication of a configuration of the FFP, and determining the configuration from the transmission including the indication of a configuration of the FFP, wherein the transmission of the configuration of the FFP includes a “tdd-UL-DL-ConfigurationCommon” field in a system information block (SIB) transmission to indicate a length of the FFP.

15. The method of claim 12, further including processing a transmission from the gNB including an indication of a configuration of the FFP, and determining the configuration from the transmission including the indication of a configuration of the FFP, wherein the FFP corresponds to a set of values including 2, 2.5, 5, and 10 ms.

16. The method of claim 12, further including processing a transmission from the gNB including an indication of a configuration of the FFP, and determining the configuration from the transmission including the indication of a configuration of the FFP, wherein the transmission of the configuration of the FFP is a system information block (SIB) transmission including a frame based equipment (FBE) starting offset value to indicate a starting position of the FFP.

17. The method of claim 12, further including processing a transmission from the gNB to indicate one of a frame-based equipment (FBE) or a load-based equipment (LBE) mode of operation, wherein the transmission to indicate one of a FBE or a LBE mode of operation includes a field in a system information block (SIB) transmission.

18. The method of claim 12, wherein a starting position of the FFP is to align with a boundary of a radio frame for communication in the operating channel

19. One or more non-transitory computer-readable media comprising instructions to cause an apparatus of a User Equipment (UE), upon execution of the instructions by one or more processors of the apparatus, to perform operations including:
determining whether a fixed frame period (FFP) for communication with a New Radio (NR) evolved Node B (gNB) on an operating channel of an unlicensed band is valid;
determining a time gap between an end of a downlink (DL) transmission burst from the gNB and a beginning of a following uplink (UL) transmission burst from the UE within a channel operating time (COT) of the FFP;
in response to a determination that the time gap is less than or equal to 16 μs, performing a CAT-1 listen-before-talk (LBT) operation to gain access to the operating channel;
in response to a determination that the time gap is more than 16 μs, performing a CAT-2 LBT operation to gain access to the operating channel; and
causing the UE to transmit the UL transmission burst to the gNB on the operating channel and within the FFP if the FFP is valid and after performing the CAT-1 or CAT-2 LBT operation.

20. The computer-readable media of claim 19, wherein a time corresponding to a last 5% of the COT or 100 μs corresponds to an idle period during which no transmissions are to occur.

21. The computer-readable media of claim 19, the operations further including processing a transmission from the gNB including an indication of a configuration of the FFP, and determining the configuration from the transmission including the indication of a configuration of the FFP, wherein the transmission of the configuration of the FFP includes a “tdd-UL-DL-ConfigurationCommon” field in a system information block (SIB) transmission to indicate a length of the FFP.

22. The computer-readable media of claim 19, the operations further including processing a transmission from the gNB including an indication of a configuration of the FFP, and determining the configuration from the transmission including the indication of a configuration of the FFP, wherein the FFP corresponds to a set of values including 2, 2.5, 5, and 10 ms.

23. An apparatus of a New Radio (NR) evolved Node B (gNB), the apparatus including:
means for causing the gNB to perform a listen-before-talk (LBT) operation, by sensing whether an operating channel of an unlicensed band is idle, in order to gain access to the operating channel within a fixed frame period (FFP);
means for, in response to a determination that the LBT operation is successful, obtaining a channel occupancy time (COT) during a valid FFP for transmission and reception on the operating channel; and
means for causing the gNB to transmit downlink (DL) transmission bursts within the valid FFP immediately after sensing the operating channel to be idle, wherein a time corresponding to a last 5% of the COT or 100 μs corresponds to an idle period during which no transmissions are to occur.

24. The apparatus of claim 23, further including means for, in response to a determination that the LBT operation is not successful, causing the gNB to drop any transmissions corresponding to an invalid FFP.

25. The apparatus of claim 23, further including means for causing a transmission from the gNB to a user equipment (UE) of a configuration of the FFP.
